(19) United States
(12) Patent Application Publication
(10) Pub. No.: US 2026/0268083 A1
(43) Pub. Date: Sep. 10, 2026

(54) MANAGING CHUNK CACHES FOR EFFICIENT RETRIEVAL-AUGMENTED GENERATION

(71) Applicant: Adobe Inc., San Jose, CA (US)

(72) Inventors: Shubham Agarwal, Durgapur (IN); Archit Gupta, Kolkata (IN); Nirmal Joshua Kapu, Bengaluru (IN); Debabrata Mahapatra, Bangalore (IN); Subrata Mitra, Bangalore (IN); Shiv Kumar Saini, Bengaluru (IN); Rounak Sharma, Ranchi (IN); Sai Narayan Sundaresan, Chennai (IN); Tong Yu, San Jose, CA (US)

(21) Appl. No.: 19/074,061

(22) Filed: Mar. 7, 2025

(51) Int. Cl. G06F 40/289; G06F 12/0893; G06F 40/284; G06F 40/40

(52) U.S. Cl. CPC G06F 40/289; G06F 12/0893; G06F 40/284; G06F 40/40

(57) ABSTRACT

The present disclosure relates to systems, non-transitory computer-readable media, and methods for managing and reusing chunk caches in processing a user query via a large language model. For example, the disclosed systems extract a first plurality of text chunks relevant to an input query, where the first plurality is arranged in a first sequence. In some embodiments, the disclosed systems determine, according to a second plurality of text chunks, a precomputed key-value cache for a text chunk of the first plurality of text chunks. The disclosed systems determine a cache reusability score for the text chunk according to dependency metrics of tokens within the text chunk and tokens within a second plurality of text chunks. In various embodiments, the disclosed systems reuse, within the large language model generating a response to the input query, the precomputed key-value cache associated with the text chunk based on the cache reusability score.

### BACKGROUND

Retrieval-Augmented Generation (RAG) is often used with Large Language Models (LLMs) to access relevant context from a custom knowledge base outside the LLM training data to generate grounded responses to a user query. In RAG, given a user query, a retriever extracts chunks of relevant text (text chunks) from a knowledge base and sends the text chunks to an LLM. During retrieval phase, relevant text chunks are extracted based on these embeddings, using a vector-similarity search to answer a user query. In the generation phase, the LLM uses the retrieved context to generate a response. The LLM processes its input prompt (retrieved text chunks and the user query) in the prefill phase, building an initial computed state (key-value cache or chunk cache) which is used in the decode phase for autoregressive token generation. The prefill phase is compute-bound because it processes all tokens of the input prompt in parallel, while the decode phase is memory bound as it generates one token at a time. In many current systems, for every query, attention-layers in LLMs fully compute the key value caches (chunk caches) for retrieved text chunks, as current systems cannot reuse chunk caches when text chunks appear at arbitrary locations with arbitrary contexts.

### SUMMARY

One or more embodiments described herein provide benefits and/or solve one or more of the foregoing or other problems in the art with systems, methods, and non-transitory computer-readable media that manage and reuse chunk caches in processing a user query via a large language model. To illustrate, in one or more embodiments, the disclosed systems manage and reuse key-value caches associated with a text chunk by evaluating contextual dependencies (e.g., attention weights, prefix discrepancies) of text chunks retrieved by a large language model. In some embodiments, the disclosed systems also include techniques for recomputing key-value caches, and a number of tokens associated with key-value caches, based on their contextual dependencies. In one or more embodiments, the disclosed systems further introduce processes for generating a map of chunk cache variants, facilitating memory storage and retrieval of chunk caches based on use frequency. In some embodiments, the disclosed systems additionally perform layer-wise preloading, via a hierarchical storage system, by loading large language model layers according to a preload buffer, thereby diminishing layer execution gaps and minimizing wait times.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures.

FIG. 1 illustrates a diagram of an environment where a cache management system operates in accordance with one or more embodiments.

FIG. 2 illustrates an overview diagram of the cache management system managing text chunks retrieved by a large language model in accordance with one or more embodiments.

FIG. 3 illustrates a diagram of the cache management system reusing key value caches to process a query in accordance with one or more embodiments.

FIG. 4 illustrates a diagram of the cache management system determining a cache reusability score of a chunk cache in accordance with one or more embodiments.

FIGS. 5A-5B illustrate a diagram of the cache management system determining reuse of a text chunk according to inter-attention and intra-attention in accordance with one or more embodiments.

FIG. 6 illustrates a diagram of the cache management system determining reuse of a text chunk according to contextualization of the text chunk in accordance with one or more embodiments.

FIGS. 7A-7B illustrate diagrams of the cache management system recomputing focused chunks across layers of a large language model in accordance with one or more embodiments.

FIG. 8 illustrates a diagram of the cache management system 102 generating a data structure for efficient chunk cache management.

FIG. 9 illustrates a diagram of the cache management system executing layer-wise preloading of chunk caches in accordance with one or more embodiments.

FIG. 10 illustrates a diagram of evaluation metrics for answers generated utilizing the cache management system compared to other systems in accordance with one or more embodiments.

FIGS. 11A-11B illustrate diagrams of time-to-first-token latency of the cache management system in accordance with one or more embodiments.

FIG. 12 illustrates a diagram of time-to-first token latency over time of the cache management system in accordance with one or more embodiments.

FIG. 13 illustrates a schematic diagram of the cache management system in accordance with one or more embodiments.

FIG. 14 illustrates a flowchart of a series of acts for reusing a precomputed key-value cache associated with a text chunk in accordance with one or more embodiments.

FIG. 15 illustrates a flowchart of a series of acts for recomputing a set of tokens within a text chunk in accordance with one or more embodiments.

FIG. 16 illustrates a flowchart of a series of acts for layer-wise preloading of chunk caches in accordance with one or more embodiments.

FIG. 17 illustrates a block diagram of an example computing device for implementing one or more embodiments of the present disclosure.

### DETAILED DESCRIPTION

This disclosure describes one or more embodiments of a cache management system that manages the storage and reuse of chunk caches (e.g., key-value caches) associated with text chunks retrieved in the processing of a query via a large language model. In many use cases, large language models in retrieval augmented generation (“RAG”) systems fully generate chunk caches for text chunks retrieved in processing a query. To improve on these existing approaches for processing queries via large language models utilizing RAG systems, in some embodiments, the cache management system reuses chunk caches in processing a query based on the contextualization of the chunk cache. As part of determining the reusability of a chunk cache, the cache management system determines the contextualization of the chunk cache due to attention weights of tokens and/or the contextualization of the chunk cache due to prefix sequencing. Further, in some embodiments, the cache management system performs processes to determine tokens within a chunk cache for recomputation where the chunk cache is reusable in processing a query. In certain cases, in processing a query, the cache management system efficiently loads layers of the large language model, utilizing a hierarchical storage system, to minimize discrepancies between prefill computation time and loading time.

As just mentioned, in some embodiments, the cache management system determines the reusability of chunk caches associated with a text chunk retrieved to process a query. In some cases, the cache management system determines the reusability of a chunk cache by evaluating the contextualization of tokens within the text chunk associated with the chunk cache. For example, the cache management system evaluates the contextualization of a chunk cache according to the attention weight of tokens associated with the chunk cache and/or the prefix overlap of the chunk cache. For example, the cache management system evaluates the cumulative attention weight of tokens within the text chunk to other tokens within the text chunk (intra-attention) and/or the cumulative attention weight of tokens within the text chunk to tokens within other retrieved text chunks (inter-attention).

In some embodiments, the cache management system reuses a chunk cache in processing a query by recomputing a number of tokens within the text chunk associated with the chunk cache. In some cases, the cache management system determines a number of tokens to recompute by determining the impact of inter-attention scores of tokens within the chunk cache on a reusability score. Accordingly, in some embodiments, the cache management system recomputes a number of tokens based on the inter-attention scores of one or more tokens and the length of the chunk cache. Alternatively (or additionally), the cache management system reuses the chunk cache without recomputation based on determining reusability scores for the tokens within the chunk cache.

In one or more embodiments, the cache management system implements an efficient inference pipeline to minimize or reduce redundant computations in the large language model by strategically reusing chunk caches across prefill requests. To facilitate such reduction, the cache management system determines which text chunks have chunk caches available and designates text chunks requiring further computation. Further, in certain embodiments, the cache management system identifies chunk caches available in high bandwidth memory, and preloads layers of a large language model based on the availability of chunk caches within a hierarchical storage system.

As suggested above, many conventional systems exhibit a number of shortcomings or disadvantages, particularly in efficiently processing queries via RAG-based large language models. To elaborate, some existing systems require full computation of chunk caches for each text chunk retrieved for processing a query. Not only does the full computation of chunk caches result in redundant computations for each query, but such processing also increases the latency of the large language model, providing for a diminished user experience and excessive cost to the system provider. The computation expense of full computation is compounded when utilizing large language models that have extensive token processing capabilities.

Typically, computational bottlenecks occur in RAG systems at prefill, even if the queries and the generated responses are short. Indeed, prefill dominates decoding in RAG, with the majority (e.g., 60% to 98%) of tokens retrieved from a knowledge base in prefill. Additionally, due to the nature of large language models requiring full processing of inputs (tokens and queries) before executing a decode phase, full computation (or recomputation) of tokens increases latency and decreases efficiency. Indeed, prefill times increase quadratically with the length of input context due to the nature of attention computation in transformer architecture. Experimenters have demonstrated that prefill times sometimes exceed 100 seconds in real production workloads using a LLaMA 3-70B model with four NVIDIA A100-80 GB GPUs, thus degrading user experience as no response is generated until the entire input context is processed.

Furthermore, for large RAG-based large language models with extensive knowledge bases, precomputed chunk caches often extend beyond GPU memory into CPU memory or hard drive storage, as GPU memory is sometimes fully expended storing the LLM parameters and the growing chunk cache during the prefill phase. Thus, retrieval of chunk caches, even with reuse of caches with identical prefills, is computationally expensive and increases time-to-first-token (“TTFT”) latency. Moreover, current RAG-based systems utilize long layer loading (prefilling a predetermined number of layers before computation). Such inefficient prefill methodologies also increase TTFT latency, requiring the large language model to perform the loading of layers before performing computations within the layers.

Due at least in part to their inefficiencies, many prior systems are also inaccurate. Current systems, while capable of reusing chunk caches with identical prefixes, are incapable of reusing chunk caches with varied prefixes. Upon encountering a precomputed chunk cache that was generated according to a different prefix sequence than the current query, RAG-based systems that reuse the precomputed chunk cache encounter degraded output quality. Other conventional systems randomly recompute tokens within a text chunk when reusing a chunk cache with a different prefix sequence, generating a query response that inaccurately answers the query compared to systems that recompute the chunk cache.

In addition to problems of inefficiency and inaccuracy, conventional RAG-based systems also experience problems of operational inflexibility. For example, current systems that rely on prefix caching preserve output quality by maintaining causal attention, but if the prefix is not identical the system cannot reuse associated chunk caches. Indeed, experimenters have demonstrated that some current systems only see identical prefixes in 18% of requests. Consequently, even slight variations in the query often results in new text chunks being retrieved or in a different sequence and the system cannot reuse associated chunk caches. As small input changes result in changed prefixes, current systems are thus rendered insufficient or ineffective.

As suggested, one or more embodiments of the cache management system improve conventional systems. For example, in one or more embodiments, the cache management system improves computational efficiency and speed over current systems. For example, experimenters have demonstrated that, by employing the intelligent cache reuse and recomputation techniques described, embodiments of the cache management system achieve a 2.5× speed improvement compared to some conventional RAG-systems. Indeed, as mentioned, conventional systems that implement RAG-based large language models suffer from the computation expense of fully computing chunk caches for text chunks, including text chunks with precomputed chunk caches. In contrast, in one or more embodiments, the cache management system reuses identical chunk caches and reuses similar chunk caches in various cases. In some embodiments, the cache management system identifies a number of tokens within a similar chunk cache (based on contextualization of tokens within the text chunk) to facilitate reuse of the chunk cache.

In some embodiments, the cache management system generates and utilizes a map that stores a certain number of chunk caches in GPU memory, keeping the most-used chunk caches accessible for processing by the large language model. Further, the cache management system, by utilizing the map, maximizes reuse and masks overheads. For example, experimenters have shown that some embodiments of the cache management system provide for a 51% reduction in GPU cost compared to certain conventional systems. Moreover, in some cases, the cache management system implements layer-wise preloading, as opposed to long layer loading, to determine the ideal prefill buffer, minimizing wait times and eliminating (or diminishing) layer execution gaps. Thus, the cache management system reduces or eliminates inefficient large language model computations, providing faster, more efficient in generation of a query response. For instance, in some embodiments, the cache management system provides 3× reduction in the 99^{th} percentile TTFT latency. Furthermore, experimenters have shown that embodiments of the cache management system achieve a 1.4× increase in throughput compared to some current systems.

Relatedly, as mentioned, embodiments of the cache management system improve accuracies of prior systems, particularly in LLM output quality. As discussed previously, in some embodiments, the cache management system determines tokens within a text chunk to recompute for reuse of a chunk, removing inaccuracies inherent in reusing chunk caches without identical prefixes. Additionally, in one or more embodiments, the cache management system determines a scaling factor for recomputation, determining a number of tokens within a text chunk to recompute to accurately mimic systems that fully recompute chunk caches. Thus, in certain cases, the cache management system accurately generates partially recomputed chunk caches, providing precise query responses without needing to fully recompute chunk caches.

Similarly, embodiments of the cache management system improve upon operational flexibility. In some embodiments, the cache management system reuses chunk caches that have identical prefixes and chunk caches that have similar prefixes, allowing for flexible usage of precomputed chunk caches in generating a response to a query via a large language model. For example, as opposed to needing to fully recompute a chunk cache if prefixes differ, which is prevalent in current RAG systems, the cache management system does not require prefix-matching to reuse chunk caches in generating a response to a large language model query.

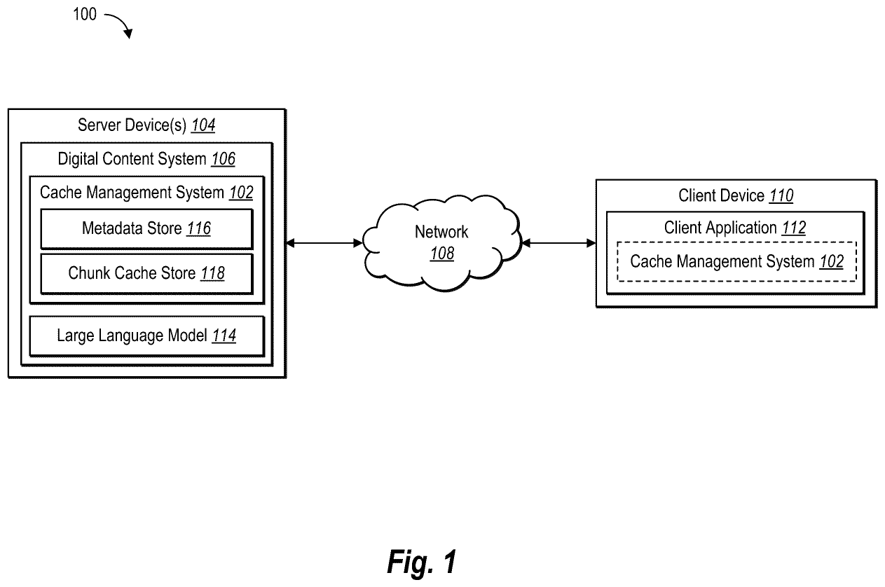

Additional detail regarding the corner-aware imitation system will now be provided with reference to the figures. For example, FIG. 1 illustrates a schematic diagram of an example system environment 100 for implementing a cache management system 102 in accordance with one or more embodiments. An overview of the cache management system 102 is described in relation to FIG. 1. Thereafter, a more detailed description of the components and processes of the cache management system 102 is provided in relation to the subsequent figures.

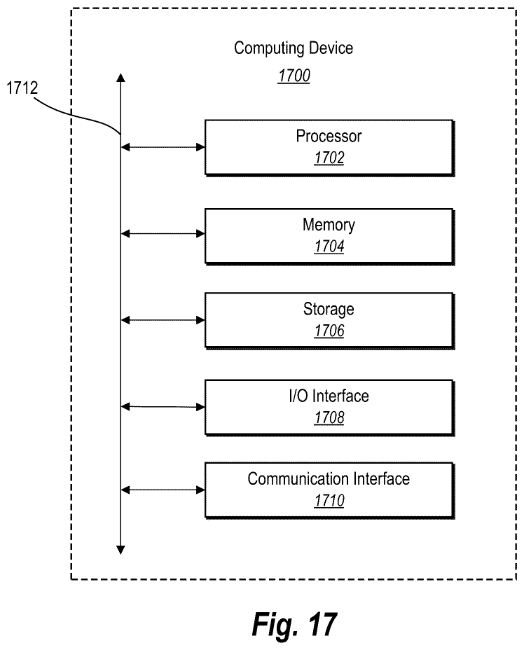

As shown, the system environment 100 includes server device(s) 104, a client device 110, and a network 108. Each of the components of the system environment 100 communicate via the network 108, and the network 108 is any suitable network over which computing devices communicate. Example networks are discussed in more detail below in relation to FIG. 17.

As mentioned, the environment 100 includes a client device 110. The client device 110 is one of a variety of computing devices, including a smartphone, a tablet, a smart television, a desktop computer, a laptop computer, a virtual reality device, an augmented reality device, or another computing device as described in relation to FIG. 17. Although FIG. 1 illustrates a single instance of the client device 110, in some embodiments, the environment 100 includes multiple different client devices, each associated with a different user. The client device 110 communicates with the server device(s) 104 and/or the digital content system 106 via network 108. For example, the client device 110 receives information from the server device(s) 104 and provides information to server device(s) 104 relating to large language model input queries.

As shown in FIG. 1, the client device 110 includes a client application 112. In particular, the client application 112 is a web application, a native application installed on the client device 110 (e.g., a mobile application or a desktop application), or a cloud-based application where all or part of the functionality is performed by the server device(s) 104. The client application 112 presents or displays information to a user, including a graphical user interface for inputting a user query for submission to a large language model (e.g., the large language model 114).

As also illustrated in FIG. 1, the environment 100 includes the server device(s) 104. The server device(s) 104 generates, tracks, stores, processes, receives, and transmits electronic data, such as text related to the input query, and/or hierarchical storage for access by the cache management system 102. For example, the server device(s) 104 receives data from the client device 110 in the form of text provided in a text input provided by a large language model (e.g., the large language model 114). In response, the server device(s) 104 provides data to the client device 110 in the form of a response to the input query, as described herein.

In some embodiments, the server device(s) 104 communicates with the client device 110 to transmit and/or receive data via the network 108. In some embodiments, the server device(s) 104 comprises a distributed server where the server device(s) 104 includes a number of server devices distributed across the network 108 and located in different physical locations. The server device(s) 104 comprise a content server, an application server, a communication server, a web-hosting server, a multidimensional server, or a machine learning server.

As further shown in FIG. 1, the server device(s) 104 also includes the cache management system 102 as part of a digital content system 106. For example, in one or more implementations, the digital content system 106 stores, generates, modifies, edits, enhances, provides, distributes, and/or shares digital content, such as embeddings of text chunks. For example, the digital content system 106 provides access to metadata store 116 and chunk cache store 118. In some embodiments, the cache management system 102 accesses chunk cache store 118, a vector database that stores the embeddings of text chunks for processing a query via a large language model 114. In various cases, the digital content system 106 accesses metadata store 116 to determine the level of accessibility of chunk caches (e.g., where the chunk cache is stored). For example, the metadata store 116 indicates where in the storage hierarchy the chunk caches (if any) associated with a text chunk are located (e.g., GPU memory, CPU memory, and/or Solid State Drive). In some implementations, the digital content system 106 provides embeddings of text chunks to particular digital profiles associated with client devices (e.g., the client device 110).

In one or more embodiments, the server device(s) 104 includes all, or a portion of, the cache management system 102. For example, the cache management system 102 operates on the server device(s) 104 to process an input query via a RAG-based large language model 114. In some embodiments, the client device 110 includes all or part of the cache management system 102. For example, the client device 110 generates, obtains (e.g., downloads), or uses one or more aspects of the cache management system 102 and/or the large language model 114. Indeed, in some implementations, as illustrated in FIG. 1, the cache management system 102 is located in whole or in part of the client device 110 (e.g., as part of the client application 112). For example, the cache management system 102 includes a web hosting application that allows the client device 110 to interact with the server device(s) 104. To illustrate, in one or more implementations, the client device 110 accesses a web page supported and/or hosted by the server device(s) 104.

Although FIG. 1 illustrates a particular arrangement of the environment 100, in some embodiments, the environment 100 has a different arrangement of components and/or may have a different number or set of components altogether. For instance, as mentioned, the cache management system 102 is implemented by (e.g., located entirely or in part on) the client device 110. In addition, in one or more embodiments, the client device 110 communicates directly with the cache management system 102, bypassing the network 108.

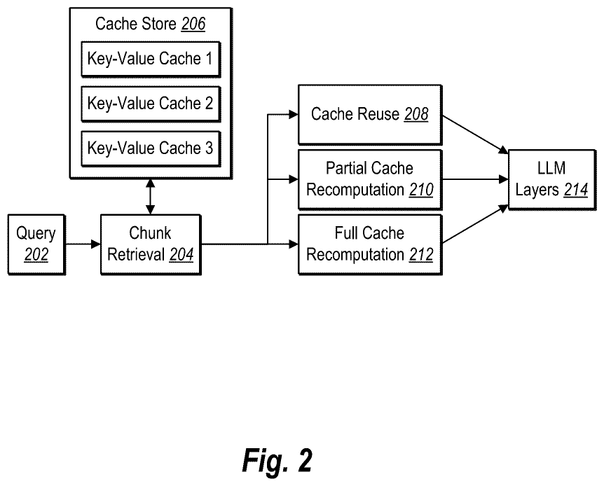

As mentioned above, in certain embodiments, the cache management system 102 performs operations for managing and reusing chunk caches associated with text chunks retrieved in processing a query via a large language model (“LLM”). In particular, the cache management system 102 manages chunk caches retrieved by an LLM for processing a query through large language model layers as part of a RAG implementation. FIG. 2 illustrates an overview diagram of the cache management system 102 managing text chunks retrieved by a large language model in accordance with one or more embodiments. Additional detail regarding the various acts and processes introduced in relation to FIG. 2 is provided thereafter with reference to subsequent figures.

As illustrated in FIG. 2, the cache management system 102 receives a query 202 for processing via a large language model. In some cases, the query is the input of a user (e.g., text prompt, voice prompt), which initiates the retrieval process by the large language model. Furthermore, the cache management system 102 processing the query as part of the input prompt (e.g., retrieved text chunks and query) provided to the LLM, which is processed by the LLM during the prefill phase.

As further illustrated in FIG. 2, the cache management system 102 performs chunk retrieval 204. The cache management system 102 extracts relevant text chunks from within a knowledge base separate from the large language model. Specifically, in some cases, the cache management system 102 detects and/or retrieves relevant text chunks from a vector database that stores the embeddings of text chunks from a specific domain as indexes. During the retrieval phase, relevant text chunks are extracted based on the embeddings, using a vector-similarity search to answer a user query. In various cases, for text chunks that have been previously retrieved by the large language model, the cache management system 102 will retrieve precomputed key-value caches (chunk caches) associated with the text chunks (e.g., from cache store 206). For example, a text chunk refers to or includes a portion or string of relevant text characters extracted from a knowledge base (e.g., a knowledge base separate from the training materials of the large language model).

As also illustrated in FIG. 2, the cache management system 102 retrieves precomputed chunk caches from a cache store 206. For instance, the cache management system 102 retrieves precomputed chunk caches for text chunks retrieved in response to query 202 that have been previously retrieved in response to prior queries. More particularly, in some cases, the cache management system 102 retrieves a variant of a chunk cache associated with a text chunk that is retrieved in processing the query 202. For example, the cache management system 102 retrieves, for a retrieved text chunk, a chunk cache variant that has the lowest reusability score, so as to minimize (or reduce) token recomputation. In some cases, a cache store 206 refers to a data structure where one or more chunk caches are identified by hashing the original chunk texts linked to the RAG vector similarity search, resulting in a map where chunk hashes serve as keys and lists of prefixes for each chunk are stored as values. Similarly, in some cases, a chunk cache variant refers to a variation of a chunk cache, dependent on the query and prefixes associated with the instance in which the text chunk was retrieved (the chunk cache context).

In some embodiments, as illustrated in FIG. 2, the cache management system 102 determines how the chunk caches associated with the retrieved text chunk should be processed by the LLM layers 214. In one or more embodiments, the LLM layers 214 are part of a large language model that includes or refers to a machine learning model trained to perform computer tasks to generate textual content. In some cases, a large language model includes a computer algorithm or a collection of computer algorithms trainable and/or tunable based on inputs to approximate unknown functions. In some embodiments, a large language model includes a neural network (e.g., a deep neural network) that analyzes a language input to generate a predicted output. For example, a large language model includes a neural network that generates code based on a natural language query. In some cases, the large language model utilizes a transformer architecture, which includes mechanisms such as self-attention, to capture contextual relationships in the data.

For example, a large language model includes a neural network with branches, weights, or parameters that change based on training data to improve for a particular task. Thus, a large language model utilizes one or more learning techniques (e.g., supervised or unsupervised learning) to improve in accuracy and/or effectiveness. Similarly, as used herein, a neural network refers to a machine learning model of interconnected nodes (or neurons) organized into layers. A neural network includes parameters or weights between neurons that are adjusted during training to minimize the error (or measure of loss) in generating predictions.

Along these lines, the machine learning models used herein are trainable and/or fine-tunable based on a diverse text corpora to perform natural language processing tasks, such as generating code. For example, the machine learning models consist of layers of interconnected artificial neurons organized in encoder and decoder blocks, which learn complex language patterns to generate textual content. In some cases, the machine learning models include models or architectures that utilize self-attention mechanisms in natural language understanding and generation. In particular, in certain embodiments, a large language model refers to an artificial neural network trained by the preference-guided code generation system to generate code based on a set of natural language queries.

As illustrated in FIG. 2, in various cases, the cache management system 102 determines whether the chunk caches will be processed, via the large language model, through full cache recomputation 212, partial cache recomputation 210, and/or through cache reuse 208. The cache management system 102, in some cases, determines how the text chunk (and the associated chunk cache) should be processed by the LLM by generating reusability scores for chunk caches associated with the text chunk. For example, a cache reusability score refers to or includes an indication of the reusability of a chunk cache in processing a query, where the score reflects the contextualization of the chunk cache as determined in processing a previous query. Depending on the reusability score for the chunk cache, in one or more embodiments, the cache management system 102 determines the level of recomputation required by the LLM (e.g., full, partial, and/or no recomputation).

In certain cases, the cache management system 102 determines that a chunk cache is fully reusable by the large language model without further computation (or recomputation). In these or other cases, the cache management system 102 determines that a chunk cache, based on the chunk cache reusability score, is processed by the LLM layers 214 via cache reuse 208. For example, performing cache reuse 208 refers to providing the chunk cache associated with a text chunk to one or more appropriate layers of a large language model without recomputing tokens within the text chunk.

As further illustrated in FIG. 2, in one or more embodiments, the cache management system 102, based on a cache reusability score, determines that a precomputed chunk cache is to be processed by the LLM layers 214 through partial cache recomputation 210. For example, partial cache recomputation refers to generating a chunk cache by recomputing a number of tokens of the text chunk associated with the chunk cache to maintain a level of output accuracy, without reprocessing all tokens within the text chunk. In some cases, the cache management system 102 determines, based on a cache reusability score, that a precomputed chunk cache associated with a retrieved text chunk is eligible for processing by the LLM layers 214 through full cache recomputation 212. In some cases, full cache computation refers to full recomputation of the tokens within text chunk associated with the chunk cache.

As shown in FIG. 2, the cache management system 102 provides text chunks and associated precomputed chunk caches (if available) to LLM layers 214 for processing the query 202. To illustrate, in various implementations, the cache management system 102, in combination with a transformer-based LLM, progressively contextualizes a sequence of tokens (represented as S={t₁ . . . tₙ}), using L transformer layers. Each layer (represented as l∈[L]), receives d-dimensional embeddings of n tokens, (represented with H^{l}∈ [symbol] ^{n×d}), as input, and outputs contextualized embeddings (represented with H^{l+1}∈ [symbol] ^{n×d}) which are known as hidden states.

In the l^{th} transformer layer, the cache management system 102 linearly transforms the d-dimensional embeddings (e.g., H^{l}) into the Query, Key, and Value matrices, (Q, K, V∈ [symbol] ^{n×d} respectively). In some embodiments, the cache management system 102 further transforms the Query and Key matrices using positional embeddings (either absolute or relative) to capture the sequential order of the tokens.

In some cases, the cache management system 102 further contextualizes the value embedding of the j^{th} token as shown in the equation below

$${\tilde{V}}_{j} = softmax ( {Q}_{j} {K}_{: j}^{T} ) {V}_{: j} ,$$

where Qⱼ∈ [symbol] ^{1×d} is the j^{th} query vector and K_{:j}V_{:j}∈R^{j×d} are all key and value vectors up to the j^{th} token. Thus, in various embodiments, the contextualized hidden state (represented by

$${H}_{j}^{l + 1} )$$

is obtained by normalizing the previous hidden state

$$( e . g . , {H}_{j}^{l} )$$

added to \tilde{V}ⱼ as applied to a feedforward neural network (represented by FNN(\tilde{V}ⱼ)).

In some embodiments, in the decode phase (e.g., text generation), the cache management system 102 performs the above sequential operation to contextualize the raw embedding (represented by

$${H}_{j}^{0} )$$

of a newly generated token at the subsequent position (represented by j=n+1). This is efficiently done with a computation (O(n)) by caching the K and V matrices of the previous n tokens at every layer. The cache management system 102 refers to the K and V matrices, in some embodiments, as a KV-cache. The cache management system 102 expands the KV-cache (e.g., chunk cache) by including the new token's key and value for subsequent (autoregressive) generation of tokens.

In one or more cases, the cache management system 102, during the prefill phase, obtains the hidden states using the matrix operation for the attention mechanism, as represented by the following equation:

$$\tilde{V} = softmax ( {QK}^{T} ⊙ M ) V ,$$

where ⊙ denotes element-wise product and M∈{0,1}^{n×n} is a lower triangular matrix, known as a causal attention mask, to ensure each token attends only to its previous tokens. The cache management system 102 preforms this operation, in some embodiments, in the prefill phase where the aim is to contextualize the prompt tokens that are available to begin with (e.g., in the computation of the hidden states H^{L}(S)). The cache management system 102 denotes the attention computation as O(n²), as both Q and K matrices are of size n×d.

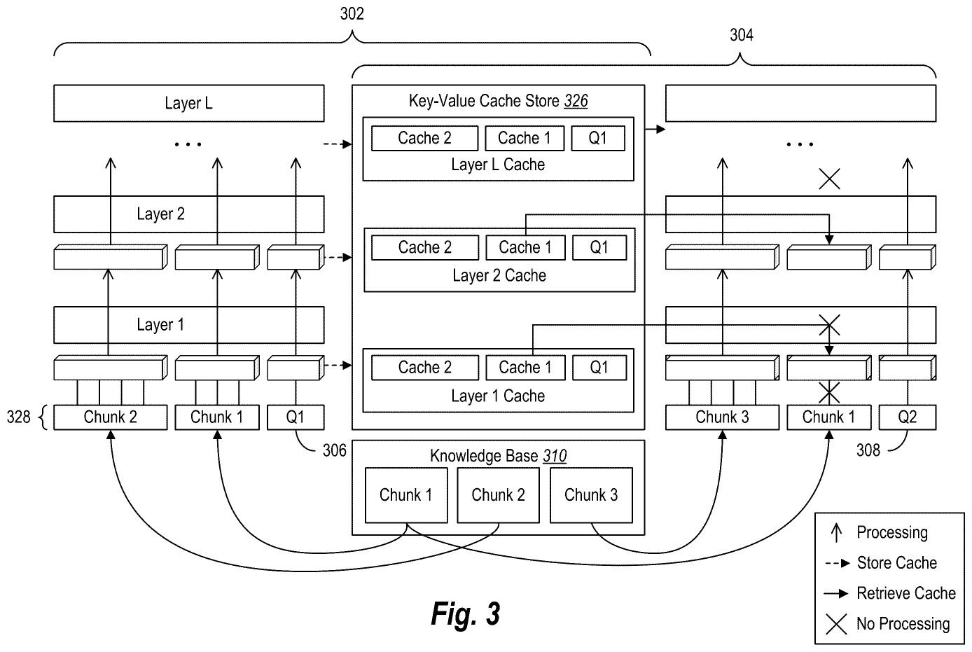

As mentioned above, in certain described embodiments, the cache management system 102 reuses chunk caches at appropriate layers of a large language model. In particular, the cache management system 102 retrieves text chunks relevant to a query and determines the reusability of chunk caches associated with text chunks according to their contextualization. FIG. 3 illustrates a diagram of the cache management system 102 reusing key value caches to process a query in accordance with one or more embodiments.

As illustrated in FIG. 3, the cache management system 102 performs chunk cache formation 302. Specifically, the cache management system, in various embodiments, generates layer-specific caches comprising a chunk cache corresponding to text chunk. The cache management system 102, in some cases, receives or detects a first query 306 for processing. For instance, the cache management system 102 receives the first query 306 as text input from a client device (e.g., the client device 110).

As also illustrated in FIG. 3, in response to first query 306, the cache management system 102 retrieves one or more text chunks from knowledge base 310 for use in processing the first query 306. Specifically, in some cases, the cache management system 102 retrieves one or more text chunks from a knowledge base 310 where the text chunks are retrieved in a first sequence. For example, in processing a first query 306, the cache management system 102 retrieves chunk 2 followed by chunk 1.

In various cases, the cache management system 102 generates a chunk cache (e.g., key-value cache) for one or more text chunks retrieved. In some embodiments, the cache management system 102 fully generates a chunk cache for a retrieved text chunk that has not previously been retrieved by the system (or previously had a chunk cache computed). In some cases, the cache management system 102 generates layer-specific chunk caches when attention computation is performed on one or more text chunks corresponding to a question. In various embodiments, the cache management system 102 stores layer-specific chunk caches (e.g., precomputed chunk caches) in a key-value cache store 326 for storage and management.

In some embodiments, the cache management system 102 stores and manages chunk caches in the key-value cache store 326 along with metadata related to the chunk caches. For example, the cache management system 102 generates a Layer 1 cache for the components of input prompt 328 and processes through LLM Layer 1. Similarly, the cache management system 102 generates a Layer 2 cache in response to the cache management system 102 processing the input prompt 328 through LLM Layer 2. The cache management system 102 continues generating layer-wise caches for input prompt 328, generating a layer L cache in response to processing input prompt 328 through LLM layer L.

As shown in FIG. 3, for subsequent queries involving a previously retrieved text chunk, the cache management system 102 performs chunk cache reuse 304. For text chunks that have been previously retrieved and have a chunk cache associated with the previous retrieval, the cache management system 102, in some cases, reuses the chunk caches. Due to possible contextualization, the cache management system 102 evaluates whether previously retrieved chunk caches are reusable.

For example, the cache management system 102 represents the retrieval of text chunks in response to a query by considering a query U (or user request) with the prompt sequence S=C₁:CₖU, where k relevant chunks to U are retrieved by the cache management system 102. In various embodiments, a precomputed chunk cache for chunk C₁ is available that was stored while serving a first query 306 U′ (e.g., Q1) with the prompt sequence S′=C′₁:C′ₖU′, where Cⱼ=Cᵢ, but the positions j and i are not necessarily the same. In these or other cases, the stored chunk cache of Cᵢ has been contextualized by C′₁:C′ᵢ₋₁. In certain embodiments, the contextualization of Cᵢ changes with varying numbers of prefix chunks and grows with more prefix chunks.

In various embodiments, apart from the number of prefix chunks, the relative ordering of the prefix chunks affects the contextualization. Contextualization, in some cases, occurs due to at least one of two reasons: a) the unidirectional attention by the causal attention mask M (as discussed previously) and b) the positional embedding that alters Q and K matrices specific to the token positions. More precisely,

$${H}_{{C}_{i}}^{L} ( {C}_{1} : {C}_{i} ) \neq {H}_{{C}_{i}}^{L} ( {C}_{1} : {C}_{( i - 1 )} {C}_{i} ) ,$$

where C₁:C₍ᵢ₋₁₎ is a permutation of the prefix chunks. In some RAG-based systems, if the prompt sequence always contains one chunk (e.g., k=1), then the chunk caches of all of the chunks can be computed independently, making them fully reusable in answering a future query. However, in many RAG-based systems, 5 to 15 chunks are retrieved to answer a query.

In some embodiments, the cache management system 102 reuses a chunk cache for a future query without further processing if the same k text chunks are retrieved in the same order (in processing the future query). However, in various cases, the number of times such ordered k-tuples that have been observed over requests (e.g., reuse density) drops with respect to k, reducing the reusability of the chunk cache. Experimenters have observed that for 3 datasets (SYS-X, 2WikiMQA, Musique), over the most recent 1000 requests, the reuse density drops as low as 5 for k=5.

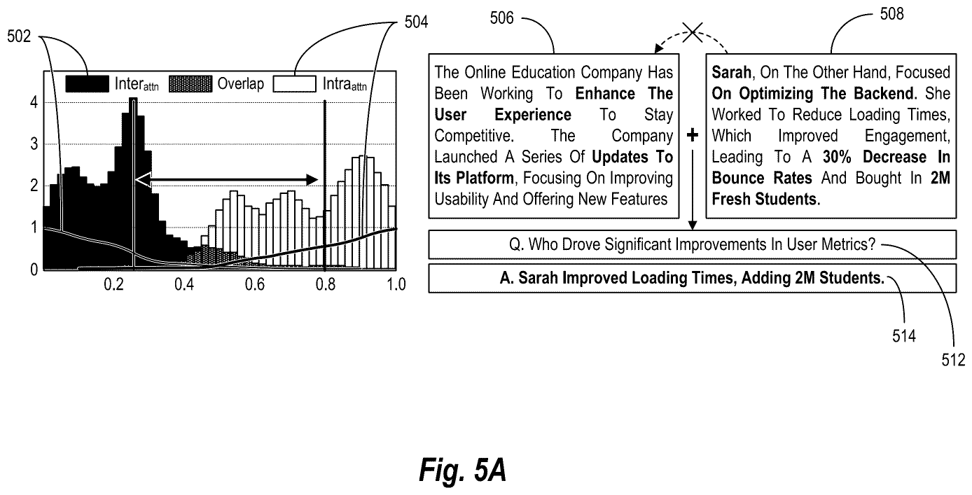

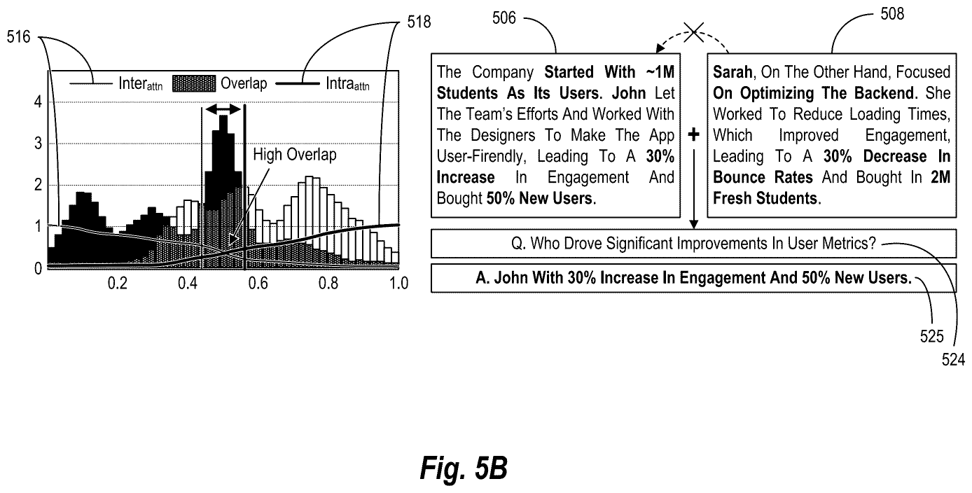

In one or more cases, a text chunk C may have more than one stored KV-cache (chunk cache) stored from serving different user requests in the past. In determining which precomputed chunk cache to use in answering a query, the cache management system 102 determines and evaluates the intra-chunk attention weights and the inter-chunk attention weights. In some cases, the cache management system 102 determines that when the values of the intra-chunk attention weights and the inter-chunk attention weights are highly overlapping (e.g., above an overlap threshold) naïve reuse of precomputed chunk caches results in an incorrect output. In other cases, the cache management system 102 determines that when the values of the intra-chunk attention weights and the inter-chunk attention weights are less overlapping (e.g., below an overlap threshold), reusing the chunk cache sometimes results in the correct answer to a query, as discussed further in relation to FIGS. 5A-5B below.

As illustrated in FIG. 3, the cache management system 102 reuses a chunk cache in processing a subsequent query (e.g., second query 308). In one or more cases, the cache management system 102 denotes the chunk cache of a text chunk C that was originally computed from H^{L}(C₁:Cᵢ:CₖU), while serving a query U (or request) at the i^{th} position (i.e., Cᵢ=C), with the equation below:

$$𝒞 ( C \vert {C}_{1} : {C}_{i - 1} ) = \{ ( {K}_{C}^{l} , {V}_{C}^{l} ) \vert l ∈ [ L ] \} ,$$

where

$${K}_{C}^{l} and {V}_{C}^{l}$$

are the key and value vectors in the l^{th} layer corresponding to the tokens in C. The cache management system 102 denotes the LLM operations, from input tokens S all the way up to the last hidden states H^{L}, as H^{L}(S).

As further illustrated in FIG. 3, the cache management system 102 determines that text chunk (e.g., text chunk 1) was used both in processing first query 306 and in processing second query 308. In some cases, the cache management system 102 determines that, due to the prior use by the cache management system 102, the key-value cache store 326 already contains a chunk cache associated with the text chunk. For example, the cache management system 102 determines that text chunk 1 was utilized in answering both first query 306 and second query 308. In some cases, as the cache management system 102 retrieves the text chunk 1, the cache management system 102 also retrieves the chunk cache associated with text chunk 1 (e.g., from Layer 1 cache).

In one or more embodiments, the cache management system 102 selects the most useful version of a chunk cache out of all the stored versions (represented by [symbol] (C| . . . )) in the key-value cache store 326, and provides the chunk cache to the relevant LLM transformer layer(s) (e.g., layer 1, layer 2, and/or layer L). For retrieved text chunks that do not have a precomputed chunk cache, in some cases, the cache management system 102 fully generates a chunk cache for that text chunk via chunk cache formation 302. In some cases, the cache management system 102 generates a chunk cache for a text chunk based on the sequence of other text chunks retrieved (prefix sequencing). Furthermore, in these or other cases, the cache management system 102 generates a chunk cache based on the prefix sequencing and/or the query received, as further discussed below.

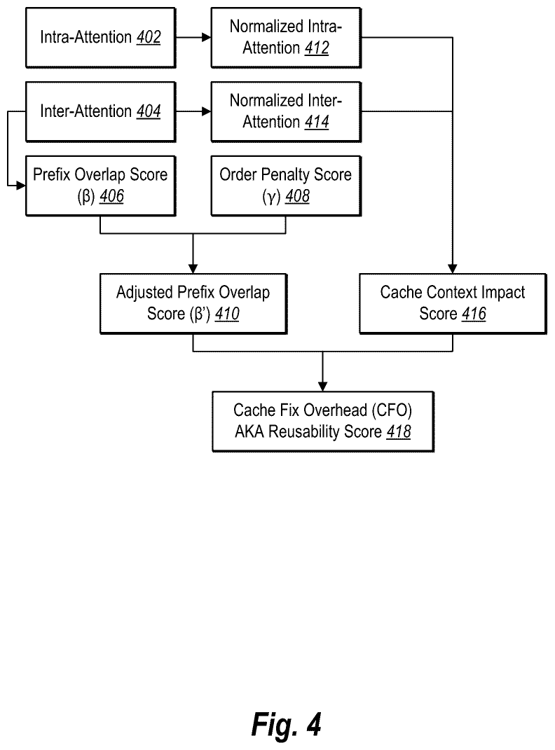

As noted above, in certain described embodiments, the cache management system 102 determines the reusability of chunk caches in processing subsequent queries. In particular, cache management system 102 determines a reusability score for a chunk cache according to the context of the chunk cache. FIG. 4 illustrates a diagram of the cache management system 102 determining a cache reusability score of a chunk cache according to contextualization in accordance with one or more embodiments.

As illustrated in FIG. 4, the cache management system 102, determines whether a text chunk is reusable in a new context based on dependency metrics of the text chunk. Specifically, in some cases, the cache management system 102 determines whether a text chunk is reusable based on intra-attention 402 (e.g., intra-attention scores) and/or inter-attention 404 (e.g., inter-attention scores). In some cases, the cache management system 102 assesses the reusability of a chunk cache by determining how much of a chunk cache's key-value computation was influenced by external context (tokens outside of the chunk) verses internal intext (tokens within the chunk). In various embodiments, the cache management system 102 determines that if a chunk is mainly influenced by its own tokens, it is more likely to produce high-quality answers when reused. A text chunk with more tokens is more reusable than text chunks with fewer tokens because tokens closer to each other have stronger attention due to positional embeddings, compared to tokens that are distant from other text chunks.

In one or more embodiments, the cache management system 102 determines inter-attention 404 of a chunk cache by determining the cumulative attention weights from tokens in the associated text chunk to tokens in text chunks earlier in a sequence of text chunks retrieved to process the query. In some cases, the cache management system 102 measures inter-attention 404 by determining the cumulative attention weight from tokens in text chunk Cᵢ to tokens in text chunk Cⱼ, with the following equation, where i<j:

$$inter ( {C}_{j} , {C}_{i} ) = {\sum }_{k ∈ {C}_{i}} {\sum }_{l ∈ {C}_{j}} {a}_{k l} ,$$

where aₖₗ is the attention weight of the k^{th} token of chunk i to the l^{th} token of chunk j.

In some cases, the cache management system 102 determines the intra-attention 402 of a chunk cache in addition (or alternatively) to the inter-attention 404 determination. In various embodiments, the cache management system 102 determines the intra-attention 402 of chunk cache by measuring the cumulative attention weight within a chunk from each token within the chunk to previous tokens within the same chunk. In some cases, the cache management system 102 determines the intra-attention of chunk Cᵢ according to the following equation:

$$i n t r a ( {C}_{i} ) = {\sum }_{k ∈ {C}_{i}} {\sum }_{l ∈ {C}_{i} : l < k} {a}_{k l} .$$

In various cases, the cache management system 102 uses the inter-attention 404 weights and intra-attention 402 weights to understand the contextualization of the text chunk. For instance, cache management system 102 uses the cumulative inter-attention 404 and the cumulative intra-attention 402 weights to determine the influence of prefix sequencing on the chunk cache. Reusability of a chunk cache (e.g., [symbol] (C₃|C₁ C₂)) for subsequent queries with different prefixes will differ depending on the text chunks retrieved, and the sequencing of the retrieval. For example, consider two cases with the prefixes (i) C₄-C₂-C₃ and (ii) C₅-C₆-C₃. As the first sequence carries the C₂ in the prefix sequencing similar to that of [symbol] (C₃|C₁ C₂), the first sequence, in some cases, is more reusable than the second sequence, which does not have any common text chunk in its prefix.

As the cache management system 102 assumes that higher prefix overlap indicates higher reusability, the cache management system 102 generates a Prefix Overlap Score 406 for a text chunk. However, in some cases, as Prefix Overlap Score 406 sums the inter-attention weights for overlapping of text chunks in a retrieved sequence, the Prefix Overlap Score 406 is order invariant and captures the subset match between the previous prefix and the current prefix. In one or more embodiments, the cache management system 102 represents the Prefix Overlap Score 406 (β) for a text chunk Cᵢ, corresponding to the current query sequence S_{new} as:

$$β ( {C}_{i} \vert {S}_{n e w} ) = \frac{{\sum }_{j ∈ {S}_{o l d} ⋂ {S}_{n e w}} inter ( i , j )}{{\sum }_{j ∈ {S}_{o l d}} inter ( i , j )} ,$$

where S_{old} denotes the set of ordered text chunks (prefix) when text chunk Cᵢ was cached.

In some cases, for two prefixes (e.g., C₁-C₂-C₃ and C₂-C₁-C₃), the Prefix Overlap Score 406 equals one. However, in such or other cases, the reusability of a text chunk in the second sequence (for example, C₃) often differs significantly due to the reordering of the prefix sequence. In some cases, this occurs because the key (K) for the text chunk is based on the relative positions of the text chunks in the retrieval sequence, leadings to changes in the inter-attention 404 score for text chunk C₃, even where the text chunks in the sequence are the same.

In some cases, to account for prefix reordering, the cache management system 102 also determines an Order Penalty Score 408, which penalizes a chunk for different ordering in a prefix sequence. The cache management system 102, in one or more embodiments, determines the Order Penalty Score 408 by determining A_{old}=(Cᵢ|Cᵢ∈S_{old}∩S_{new}), which denotes the ordered sequence of text chunks as retrieved according to S_{old}. Similarly, the cache management system 102, in determining the Order Penalty Score 408 for a text chunk, determines A_{new}, which denotes the ordered sequence as retrieved according to the current query sequence (e.g., S_{new}). As such, the cache management system 102 defines the Order Penalty Score 408 for text chunk Cᵢ with respect to S_{new} as the normalized Kendall's Tau distance between vector A_{old} and A_{new}. In various cases, the cache management system 102 determines the Order Penalty Score 408 (γ) according to the following equations:

$$γ ( {C}_{i} \vert {S}_{n e w} ) = \frac{D}{T} ,$$

$$T = ( \begin{matrix}m \\ 2\end{matrix} ) = \frac{m ( m - 1 )}{2} ,$$

where m=|S_{old}∩S_{new}| and D is the number of discordant pairs between A_{old} and A_{new}. In some cases, the cache management system 102 determines that a higher number of discordant pairs (higher value of D) indicates a greater discrepancy in ordering, leading to a higher penalty for reuse.

In various embodiments, to compensate, the cache management system 102 adjusts the Prefix Overlap Score 406 (β) to account for the discrepancy in prefix ordering by penalizing it. In one or more embodiments, the cache management system 102 determines an Adjusted Prefix Overlap Score 410 to account for the discrepancy. In some cases, the cache management system 102 determines the Adjusted Prefix Overlap Score 410 (β′) according to the following equation:

$${β}^{′} ( {C}_{i} \vert {S}_{n e w} ) = β ( {C}_{i} \vert {S}_{n e w} ) \cdot ( 1 - γ ( {C}_{i} \vert {S}_{n e w} ) ) .$$

In one or more cases, the cache management system 102 evaluates the reusability of a chunk cache associated with a text chunk by determining how much of the chunk cache associated with the text chunk is contextualized by its prefix. In some embodiments, a chunk cache is more reusable if it is less influenced by its prefix and better reflects its own tokens. For example, for the chunk sequence (prefix sequence) C₁-C₂-C₃, an inter-attention 404 score associated with C₃ indicates how much the chunk cache associated with C₃ reflects the contexts of preceding text chunks C₁ and C₂. In some cases, the cache management system 102 aggregates the effects of inter-attention 404 and intra-attention 402 by calculating the normalized sum of inter-attention scores 412 between prior text chunks and/or the normalized intra-attention score 414 of a text chunk. In some embodiments, the cache management system 102 represents the normalized sums of attention scores by the following equations:

$$a = {\sum }_{j < i} \frac{inter ( {C}_{i} , {C}_{j} )}{{l}_{i} \cdot {l}_{j}} and b = \frac{intra ( {C}_{i} )}{{l}_{i}^{2}} ,$$

where a is the normalized sum of inter-attention scores 412 between text chunk Cᵢ and Cⱼ, where Cⱼ denotes the prefix chunks of Cᵢ when it was cached, and b is the normalized intra-attention score 414 of text chunk Cᵢ. In some embodiments, the cache management system 102 normalizes by text chunk length l to ensure comparability across text chunks of varying sizes. In various cases, a higher normalized attention ratio of normalized inter-attention to normalized intra-attention (e.g., a higher a/b ratio) indicates greater contextual influence on the chunk cache of the text chunk.

However, in some cases, as the value of the normalized attention ratio (e.g., a/b) is unbounded across chunks, the cache management system 102 ensures the normalized attention ratio value is bounded by applying a sigmoid function. In various embodiments, the cache management system 102 applies the sigmoid function to normalize the normalized attention ratio to a 0-1 range, indicating the degree of contextualization. The cache management system 102 utilizes the normalized attention ratio to define the Cache Context Impact 416 (“CCI”) for a text chunk C. The cache management system 102 represents the Cache Context Impact 416 by the following equation.

$$CCI ( {C}_{i} ) = \frac{1}{1 + {e}^{- \frac{a}{b}}}$$

The cache management system 102 generating a high value (close to 1) of a CCI 416 related to a text chunk indicates that the text chunk is highly contextualized, reducing its potential for reuse unless the prior prefix context closely matches the prefix context of the text chunk as retrieved in response to the current query.

In some cases, the cache management system 102 determines a cache reusability score 418 (Cache Fix Overhead or “CFO”) based on the Adjusted Prefix Overlap Score 410 and/or the ache context impact score. In one or more embodiments, the cache management system 102 determines the reusability score based on the CCI 416, which captures the text chunk's contextual dependency, while the Adjusted Prefix Overlap Score 410 reflects prefix mismatch. In some embodiments, the Cache Fix Overhead (cache reusability score 418) for a text chunk Cᵢ is represented by the following equation:

$$C F O ( {C}_{i} \vert {S}_{n e w} ) = α \cdot CCI \cdot ( 1 - {β}^{′} ) .$$

Additionally, in some cases, the cache management system 102 bases the reusability score 418 on a scaling factor for adjusting recomputation. The scaling factor determines the desired quality level of the large language model output using the recomputed chunk cache. To determine the scaling factor, the cache management system 102 assesses the ROUGE-F1 scores for various scaling factor values and chooses the scaling factor that meets the desired output quality level. For instance, a scaling factor of one may be chosen to achieve a ROUGE-F1 score greater than 0.85 in typical scenarios. In some cases, the cache management system 102 uses the following pseudo code to determine the scaling factor (α):

Algorithm 1 - Optimizing α for Cache Fixing

```
Objective: min_{α}Avg(CFO)_{α}
Constraint: F₁_{_{α}} ≥ F₁_{ₘᵢₙ} (e.g., 0.85)
Initialize α with a large value
Step size h
repeat
    $Compute gradient : \frac{df ( α )}{d α} = Avg ( CCI \cdot ( 1 - {β}^{′} ) )$
    Update α:
        $α ← α - h \cdot ( \frac{df ( α )}{d α} ) \cdot ( {F}_{{1}_{α}} - {F}_{{1}_{min}} )$
```

until F₁ score meets target and CFO is minimized.
   In some cases, the cache management system 102 uses Algorithm 1 to optimize the scaling factor (e.g., α) for minimizing CFO while ensuring an F1 score threshold by running the algorithm on a subset of representative queries from any given dataset or workload. The algorithm computes gradients based on CCI and prefix mismatch and iteratively updates the scaling factor using a suitable step size (e.g., h) until the target F1-ROUGE value is reached.

As noted above, in certain described embodiments, the cache management system 102 utilizes intra-attention and/or inter-attention scores to determine chunk cache reusability. Additionally, the cache management system 102 determines that, in context, where there is high overlap (e.g., above a threshold amount, percentage, or proportion) between inter-attention and intra-attention weights the chunk cache has low reusability. FIGS. 5A-5B illustrate diagrams of the cache management system 102 determining reuse of a text chunk according to inter-attention and intra-attention in accordance with one or more embodiments.

As illustrated in FIG. 5A, the cache management system 102 determines that a text chunk is reusable based on inter-attention 502 and/or intra-attention 504 scores of the text chunk. In particular, cache management system 102 retrieves relevant text chunks (e.g., first text chunk 506 and second text chunk 508) to construct an input prompt containing a query 512. The cache management system 102 similarly retrieves the precomputed chunk caches of first text chunk 506 and second text chunk 508.

As further illustrated in FIG. 5A, the cache management system determines the intra-attention 504 within a retrieved text chunk (e.g., second text chunk 508). In some embodiments, cache management system 102 additionally (or alternatively) determines the inter-attention 502 between the retrieved text chunk and text chunks retrieved prior to the retrieved text chunk (e.g., first text chunk 506 and second text chunk 508). In one or more embodiments, the cache management system 102 determines that the overlap between the inter-attention 502 and the intra-attention 504 is sufficiently low (e.g., below an overlap threshold), leading to the correct answer 514 to a user query 512. In various cases, the cache management system 102 generates attention distributions where the inter-attention 502 is less than the intra-attention 504, and thus the answer 514 (without letting second text chunk 508 attend to first text chunk 506) is correct. In one or more cases, the answer 514 is correct due to less overlap, indicating little contextualization.

In FIG. 5B, the cache management system 102 determines inter-attention 516 and intra-attention 518 scores as discussed in regard to FIG. 5A. However, in some embodiments, when the values of intra-attention 518 and inter-attention 516 distributions are highly overlapping (e.g., above an overlap threshold), the cache management system 102 determines that reuse (e.g., naïve reuse) of the chunk caches associated with the text chunks results in the incorrect output. Specifically, in some cases, the cache management system 102 determines that reuse of a second text chunk 508 that is contextualized by a first text chunk 506 results in the incorrect answer 525 to a query 524. In one or more embodiments, the cache management system 102 determines that inter-attention 516 is not less than intra-attention 518, and, without letting second text chunk 508 attend to first text chunk 506, the large language model generates an incorrect answer 525. The cache management system 102 thus corrects such errors through inter-attention 516 and intra-attention 518 to determine when cache reuse is appropriate and when recomputation should be implemented.

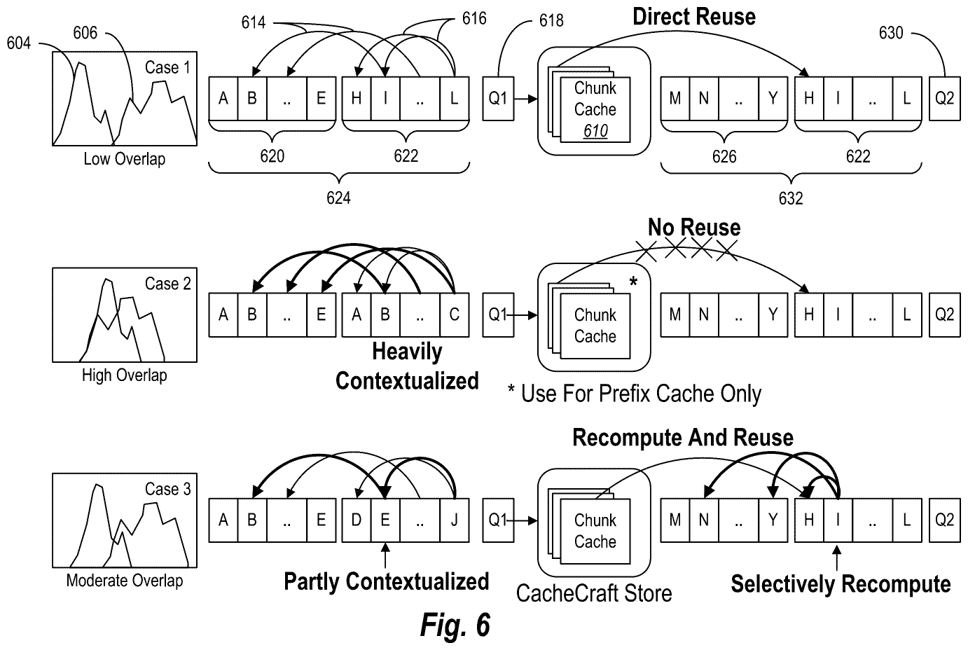

As mentioned above, in certain described embodiments, the cache management system 102 utilizes a reusability score to determine the reusability of chunk caches. In addition, the cache management system 102 determines the reusability score of a chunk cache based on the contextualization of the context of the text chunk associated with the chunk cache. FIG. 6 illustrates a diagram of the cache management system 102 determining reuse of a text chunk according to contextualization of the text chunk in accordance with one or more embodiments.

As illustrated in FIG. 6, in some embodiments, the cache management system 102 determines that in Case 1, a first context 624 associated with a chunk cache has low contextualization (e.g., below a contextualization threshold). For example, cache management system 102 determines that a second text chunk 622, in relation to a first text chunk 620, is directly reusable in a second context 632. In particular, the second text chunk 622 is directly reusable in a second context 632 where the second text chunk 622 is retrieved subsequent to a third text chunk 626 and in response to a second query 630.

In some cases, the cache management system 102 determines that, based on the inter-attention 604 and/or intra-attention 606 of the first context 624 (e.g., the original query context), the chunk cache 610 has a low contextualization. Furthermore, the cache management system 102 alternatively (or additionally) determines that the original context has low contextualization due in part to the low overlap between inter-attention 604 and intra-attention 606. In various cases, the cache management system 102 determines that a chunk cache has low contextualization based on a high reusability score associated with the chunk cache (e.g., the reusability score of the chunk cache is above a reusability threshold).

As further shown, in various embodiments, the cache management system 102 determines that in cases of low contextualization, the chunk cache is self-contextualized, allowing for chunk cache reuse even within a new context. For instance, the cache management system 102 determines that the second text chunk 622 is self-contextualized due to high contextualization (as shown by high contextualization indicators 616) between tokens within second text chunk 622. Additionally, cache management system 102 determines low contextualization of second text chunk 622 due to low contextualization (indicated by low contextualization indicators 614) between tokens of the second text chunk 622 and tokens of the first text chunk 620. In some embodiments, the cache management system 102 determines that, based on a low context determination (related to self-contextualization as shown by high contextualization indicators 616) below a context determination threshold, that the chunk cache is directly reusable in processing the current query 618 without recomputation of the chunk cache associated with second text chunk 622.

As further illustrated in FIG. 6, as in Case 2, the cache management system 102 determines that a chunk cache context has high contextualization. Specifically, the cache management system 102 determines that the original context of the chunk cache is heavily contextualized (e.g., above a contextualization threshold) by one or more text chunks in the original context. The cache management system 102 determines the level of contextualization of the original context of the chunk cache (via a reusability score as discussed previously) and determines the level of reusability of the chunk cache. In cases where there is high contextualization, the cache management system 102 determines that the chunk cache cannot be reused. In one or more cases, the cache management system 102 determines that a chunk cache is highly contextualized based on an associated reusability score being below a reusability score threshold. In various embodiments, when the cache management system 102 determines that the chunk cache cannot be reused, the cache management system 102 fully recomputes the chunk cache, as related to the new context.

As further shown in FIG. 6 by Case 3, in one or more embodiments, the cache management system 102 determines that a context associated with a chunk cache has moderate contextualization (e.g., between a first contextualization threshold and a second contextualization threshold). As shown, the cache management system 102 determines that, in the original context of a chunk cache, the text chunk was partially contextualized. In cases of moderate contextualization, the cache management system 102 determines that the chunk cache is partially reusable. The cache management system 102, in these or other embodiments, determines the chunk cache is moderately contextualized based on a reusability score associated with the chunk cache indicating moderate contextualization (e.g., a reusability score between a first reusability score threshold and a second reusability score threshold). In some cases, the cache management system 102 determines that chunk caches with original contexts that are partially contextualized are reusable with selective recomputation.

As shown, in some cases, the cache management system 102 determines that certain tokens (e.g., token E as illustrated) of the text chunk, in the original context, were highly contextualized. In these or other cases, the cache management system 102 selectively recomputes the one or more tokens that are contextualized. The cache management system 102 determines which tokens are most contextualized by generating intra-attention scores for each token of a text chunk associated with the chunk cache, as discussed further below.

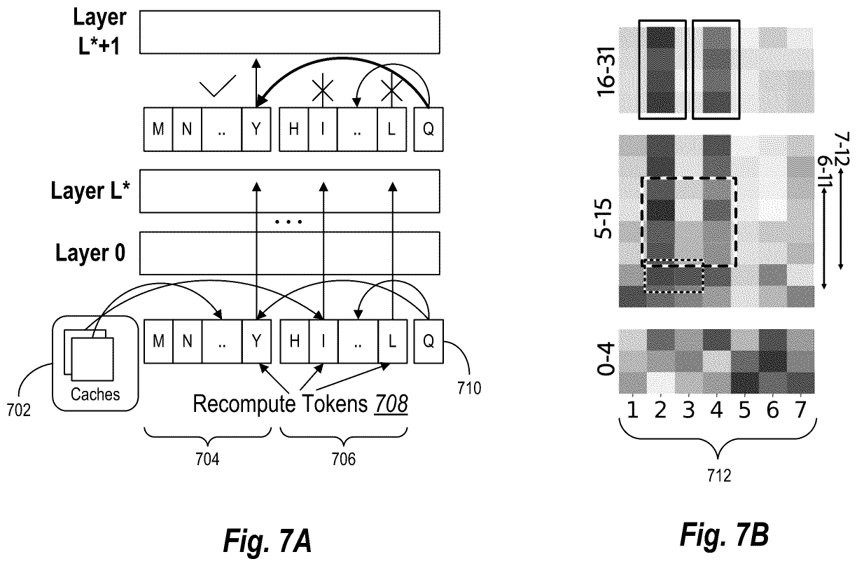

As mentioned above, FIGS. 7A-7B illustrate diagrams of the cache management system 102 recomputing focused chunks across layers of a large language model in accordance with one or more embodiments. In some embodiments, the cache management system 102 determines one or more chunk caches 702 are partially reusable in processing a query. In cases where the one or more chunk caches 702 are determined to be partially reusable (as based on the CFO of the chunk cache), the cache management system 102 determines a subset of tokens within the one or more text chunks (e.g., first text chunk 704 and second text chunk 706) associated with the one or more chunk caches 702. In some cases, the cache management system 102 determines the subset of tokens by further determining which critical tokens significantly impact the CCI score of the chunk caches. Recomputing this subset of critical tokens, in some cases, reduces output deviation.

In some embodiments, the cache management system 102 reuses one or more chunk caches 702 that have moderate contextualization by recomputing a subset of tokens with the highest inter-attention scores (relative to a prior context). In some cases, the number of top tokens (N) are represented as N=CFO·l, where CFO is the normalized cache fix overhead score and l is the text chunk length. Furthermore, in various implementations, the cache management system 102 selects the top-N contextualized tokens for chunk Cᵢ via the following equation:

$${𝒯}_{i} = \{ {T}_{k} ∈ {C}_{i} \vert k ∈ arg {top}_{N} {\sum }_{j < i} i n t e r ( {T}_{k} , {C}_{j} ) \} ,$$

where inter(Tₖ, Cⱼ) denotes the inter-attention score between token Tₖ within chunk Cᵢ and context Cⱼ, ensuring the selection of the most contextualized tokens for recomputation.

As illustrated in FIG. 7A, in some cases, the cache management system 102 halts the recomputation of one or more text chunks to reduce runtime computation costs. Specifically, the cache management system 102 determines which, of the text chunks to recompute, are focused text chunks and which text chunks are unfocused text chunks. In some cases, the cache management system 102, based on the focused/unfocused determination, halts the recomputation of the text chunk. For example, the cache management system 102 determines that a first text chunk 704 and a second text chunk 706 are eligible for selective recomputation. The cache management system 102 determines a number of recompute tokens 708 of each text chunk for recomputation by a large language model.

In one or more embodiments, the cache management system 102 monitors the attention each text chunk receives for the current query to determine focused chunks. Specifically, the cache management system 102 determines focused text chunks by analyzing inter-attention scores between the query and the text chunks across transformer layers. For instance, the cache management system 102 determines that first text chunk 704 is a focused text chunk, which the large language model will process through all layers of the large language model. Furthermore, the cache management system 102 determines that the second text chunk 706 is an unfocused text chunk. Upon determination that the second text chunk 706 is an unfocused text chunk at a determination LLM layer (e.g., LLM layer L*), the cache management system 102 halts recomputation of the tokens of second text chunk 706.

The cache management system 102 determines that a text chunk is unfocused as inter-attention scores of the text chunks stabilize. In some cases, the cache management system 102 determines that stabilization has occurred when the inter-attention scores for one or more text chunks remain significantly higher than one or more other text chunks across LLM layers. For example, the cache management system 102, in Layer 0, determines that first text chunk 704 and second text chunk 706 both have high inter-attention scores as related to the query 710 (as indicated by the bolded arrows). However, in the determination LLM layer (e.g., layer L*), the cache management system 102 determines that the first text chunk 704 maintains high inter-attention scores (as indicated by the bold arrow), while the second text chunk 706 has a low inter-attention score (as indicated by the non-bold arrow).

In FIG. 7B, the cache management system 102 determines which text chunks 712 are focused text chunks as inter-attention scores of the text chunks 712 stabilize. For example, in about 80% of some queries, experimenters found that focused text chunks stabilize between layers 10 and 15 for the LLaMA-3-8B model. In some embodiments, the cache management system 102 terminates recomputation of early for unfocused text chunks (text chunks that are not focused text chunks). In some cases, the cache management system 102 determines focused chunks according to the following pseudo code:

Algorithm 2: Predicting Focused Chunks

```
$Require : {Q}_{inter}^{l} : layer - wise inter - attention score$
Require: w: layer confidence window
Ensure: final_{K}: final top-k “focused” chunks
Ensure: L*: layer threshold for recomputation
    topK ← []
    for each layer L do
        ${Q}_{inter} ← {\sum }_{l = 0}^{L} {Q}_{inter}^{l}$
        SortQ ← sort(Qᵢₙₜₑᵣ, descending)
        D ← [sortQ[i] − sortQ[i + 1] | i ∈ 0 ... n − 2]
        p(i) ← [sortQ[i] − sortQ[i + 1] | i ∈ 0 ... n − 2]
        $H ← [ - {\sum }_{j = 0}^{i} p ( j ) \cdot log ( p ( j ) ) \vert i ∈ … n - 2 ]$
        D_{H} ← [H[i] − H[i − 1] | i ∈ 1 ... n − 2]
        i* ← argmax(D_{H})
        topK.append(chunks till i*)
        if L ≥ w & len(set(topK[L − w : L])) == 1 then
            final_{K}, L* ← topK[L], L
            Break
        end if
    end for
    return final_{K}, L
```

where, for any given question, the cache management system 102 calculates the inter-attention scores for text chunks of each layer of a large language model. In some cases, the cache management system 102 represents the inter-attention scores for n−1 text chunks for each layer l of a large language model, for a given question q by the following equation.

$${Q}_{inter}^{l} = \{ {inter}_{l} ( {C}_{i} , q ) \vert 1 \leq i \leq n \} ∀ l .$$

The cache management system 102 sorts the inter-attention scores for each layer (from largest to smallest or from smallest to largest). In some cases, the cache management system 102 calculates the entropy change (represented by D_{H}) to detect the text chunks with relevance gaps. In one or more embodiments, the cache management system 102 identifies the top text chunks with the highest focus, based on the relevance gaps, until the set of focused chunks stabilizes over a confidence window. In various cases, the cache management system 102 determines the set of focused chunks by further determining a confidence window of a number of LLM transformer layers. For example, the cache management system 102 determines that between layers 6 and 7, there was a large entropy change for text chunk 3. However, from LLM layers 7-10, there were no large entropy changes. Furthermore, between LLM layers 7-10, cache management system 102 determines that inter-attention scores for text chunks 2 and 4 consistently remained above the rest of the text chunks and designates them as focused chunks. As such, the cache management system 102 continues recomputation of the focused chunks and terminates recomputation of the unfocused chunks.

In one or more embodiments, the cache management system 102 determines focused chunks at a particular layer (e.g., at a determination LLM layer). In some cases, the cache management system 102, based on determining a particular layer where the focused chunks are determined, terminates recomputation for chunks that are not in the focused set (e.g., unfocused chunks). In some embodiments, researchers observe that termination of text chunk recomputation reduces necessary token recomputation by 55% while maintaining similar output quality.

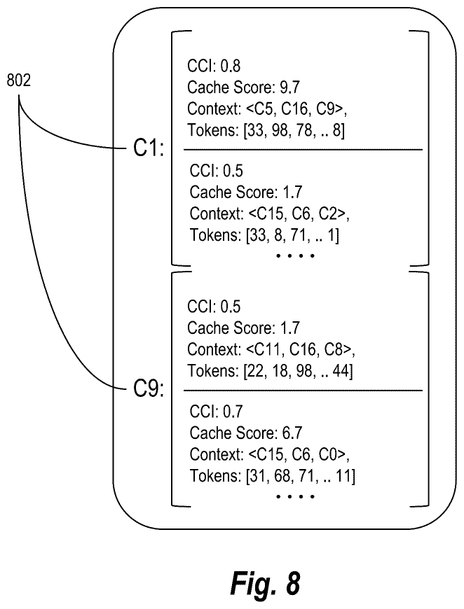

As noted above, in certain embodiments, the cache management system 102 generates a key-value cache store to manage one or more chunk caches. In addition, the cache management system 102 utilizes a key-value cache store to manage variants of chunk caches. FIG. 8 illustrates a diagram of the cache management system 102 generating a data structure for efficient chunk cache management.

As illustrated in FIG. 8, the cache management system 102, in some cases, maintains a chunk cache data structure (e.g., key-value cache store) for efficient lookup, retrieval, and/or eviction of chunk caches associated with text chunks 802. In various embodiments, the cache management system 102 identifies each chunk cache within the data structure by hashing the original text chunks linked to a RAG vector similarity search.

As further illustrated in FIG. 8, the cache management system 102, in some cases, generates a map (e.g., data structure or key-value cache store) where the chunk hashes serve as keys and/or lists of prefixes where one or more text chunks 802 are stored as values. Specifically, in some embodiments, the cache management system 102 generates a key-value cache store that has the capability to store N×M chunk cache instances. In various embodiments, the cache management system 102 generates a N×M data structure, with N text chunks (the number of keys in the map) having M variants. The variants aid the cache management system 102 recover from cases where the initial chunk cache may not be optimal (e.g., excessive token recomputation due to high contextualization), while subsequent chunk cache variants may be more reusable for common contexts.

In some cases, the cache management system 102 determines the optimal variant of a chunk cache for a request (e.g., in processing a query provided to a large language model). As shown in FIG. 8, the cache management system 102, in addition to chunk cache variants, stores various metadata associated with the chunk cache variants. For example, the cache management system 102 stores the CCI value and/or an ordered list of token indices needed recomputation within the key-value cache store. To find the optimal variant of a chunk cache for a request, the cache management system 102 generates a reusability score for each available variant (represented by CFO=CCI·(1−β′)), as discussed previously. The cache management system 102, in various cases, selects the chunk cache variant with the lowest reusability score to minimize token recomputation (while maintaining output quality).

In one or more cases, the cache management system 102 updates the key-value cache store. In some cases, cache management system 102 updates a frequency reuse metric associated with each chunk cache variant. Mathematically, the frequency reuse metric (fᵣ), in some embodiments, is represented as fᵣ+=1/CFO. Consequently, in some cases, chunk caches with higher prefix matches or less contextualization become more reusable, as indicated by increasing the frequency reuse metric (e.g., fᵣ) over time.

In some embodiments, when the cache management system 102 retrieves a text chunk (in response to a query) that does not have a precomputed chunk cache available with an identical prefix in the key-value cache store, the cache management system 102 adds a new variant until cache management system 102 generates a data structure with N×M instances. In various cases, where the data structure contains N×M instances, the cache management system 102 periodically evicts chunk caches with the lowest frequency reuse metric to make room for more effective variants. This allows for diverse configurations of the data structure, ranging from one popular text chunk with N×M variants, to N×M different text chunks, each with a single variant. In one or more embodiments, the cache management system 102 determines M and N by the popularity and/or reusability of the chunk caches, the RAG setting (e.g., the number of text chunk retrieved), the architecture (e.g., GPU/CPU memory size and/or interconnects) and/or the deployment configuration of the large language model.

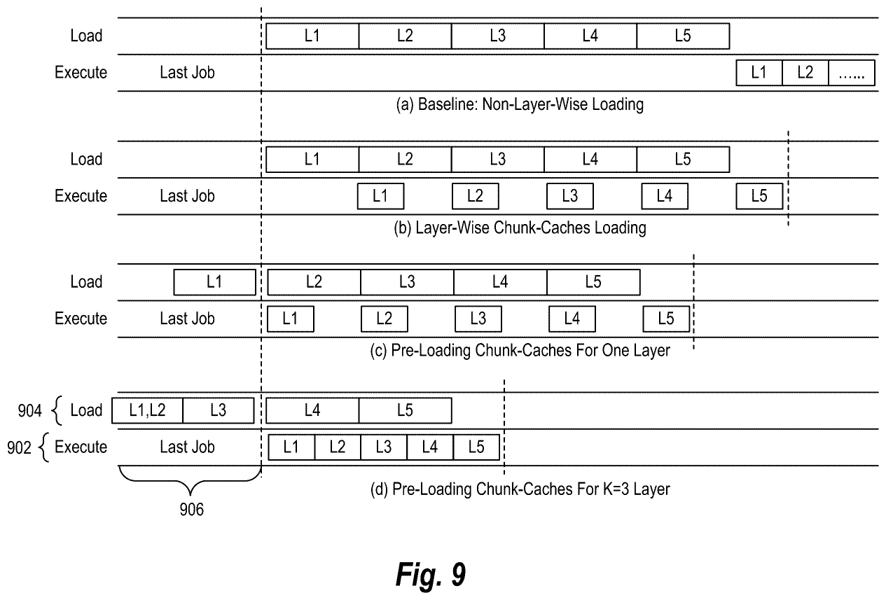

As mentioned above, in some embodiments, the cache management system 102 implements a large language inference pipeline to reduce or minimize redundant computations in RAG. Additionally, the cache management system 102 implements the LLM inference pipeline by strategically reusing chunk caches across prefill requests. FIG. 9 illustrates a diagram of the cache management system 102 executing layer-wise preloading of chunk caches in accordance with one or more embodiments.

In certain cases, for a query, the prefill request consists of ordered text chunks, provided by RAG. In response to the query, and subsequent identification of text chunks, the cache management system 102 queries the metadata store (a CPU-memory-based lookup table) to determine which text chunks have their chunk caches available for processing through the large language model. In some cases, based on the metadata store query, the cache management system 102 classifies text chunks from the ordered text chunks into two subsets based on the availability of the chunk caches. The cache management system 102 designates text chunks that have chunk caches available for processing as C-hit (within a C-hit subset). Additionally, the cache management system 102 designates the text chunks that do not have text chunks available for processing as C-miss (within a C-hit subset).

Based on the designation of C-hit or C-miss, the cache management system 102 generates an inference plan, designating text chunks in the C-miss subset for chunk cache computation by the large language model. Additionally, the cache management system 102 designates text chunks in C-hit for chunk cache retrieval. Furthermore, the cache management system 102 uses metadata retrieved from the metadata store for the text chunks in C-hit. The cache management system 102 utilizes the metadata for the C-hit text chunks to determine, for each text chunk, the reusability score of the text chunk (e.g., Adjusted Prefix Overlap score, the Chunk Context Impact score, and/or the Cache Fixing Overhead). Based on the reusability scores, the cache management system 102 identifies the top-N contextualized tokens to recompute for each C-hit chunk cache.

As discussed previously, the cache management system, in some cases, 102 utilizes a hierarchical storage system to store chunk caches. Specifically, the cache management system 102 manages chunk cache storage efficiently across Graphics Processing Unit (“GPU”) High Bandwidth Memory (“HBM”), host or Central Processing Unit (“CPU”) memory, and Solid State Drive (“SSD”). In some cases, a fixed portion of GPU memory is allocated for fast access, while host memory and SSD provide additional storage capacity. Chunk caches, in one or more embodiments, are initially kept in HBM, with the chunk cache metadata stored separately (e.g., in a metadata store).

In various cases, the cache management system 102 implements a hierarchical storage policy to ensure that highly reusable text chunks remain in HBM while low-reuse text chunks (or variants) are progressively swapped to host (CPU) memory, and later to SSD for longer-term storage, before eventual eviction if chunk cache reuse potential is low. As discussed further below, the cache management system 102, to offset the loading time of chunk caches from non-HBM locations, employs preloading techniques that start to move the caches to GPU memory. In some cases, the cache management system 102 moves chunk caches to GPU memory asynchronously, while requests are still in the queue. If the chunk caches are available for reuse in GPU memory when the request is ready to be executed, the cache management system 102 uses it. In cases where the requested chunk cache is not available in GPU, the cache management system 102 defaults to prefill from scratch starting from input text tokens.

If the required chunk cache is not already in HBM (GPU memory), the system loads the chunk cache in C-hit from the host or network-connected SSD into HBM, based on file location pointers provided by the text chunk metadata. In some cases, the transfer is on the path for inference and results in significant access overhead. To address overhead, the cache management system 102 employs a layer-wise preloading scheme. FIG. 9 illustrates a diagram of the cache management system executing layer-wise preloading of chunk caches in accordance with one or more embodiments.

As illustrated in FIG. 9, cache management system 102 overlaps computation of a current layer of a large language model (e.g., transformer LLM) with loading of one or more chunk cache(s) for a subsequent layer. In particular, the cache management system overlaps loading of a subsequent layer with computation of new text chunks in C-miss and recomputation of contextualized text chunks (e.g., partial selective token recomputation or full recomputation). While the GPU executes the current layer in the execution pipeline 902, the chunk caches for the subsequent layer are concurrently loaded from host memory or SSD into the loading pipeline 904. This ensures that when the GPU begins computing attention for the subsequent layer, the corresponding chunk caches are already available in the execution buffer, reducing or minimizing delays.

In some cases, preloading the loading pipeline 904 does not fully overlap with computation in the execution pipeline 902 as the chunk cache loading time exceeds the computation time for a layer, occurring often when loading from an SSD. To address this, the cache management system 102 reserves an HBM read buffer 906 that allows the cache management system 102 to preload the chunk caches for more layers in advance. To determine the optimal buffer size for preloading, the cache management system 102 determines a number of layers to preload, based on one or more of the total number of layers and/or the ratio of prefill computation time to key-value loading time.

As illustrated in FIG. 9, the cache management system 102 aims to preload a certain number of layers (represented by k) such that the chunk caches for the remaining layers (represented by L−k) can be loaded within the computation time for (L−1) layers. In one or more cases, the cache management system 102 represents the prefill buffer layers (k) with the following equation:

$$k = ( L - 1 ) ( 1 - \frac{{T}_{p r e f i l l}}{{T}_{l o a d}} ) + 1 ,$$

where T_{prefill} indicates prefill computation time and T_{load} indicates key-value (or chunk cache) loading time. In some cases, when the key-value loading time exceeds prefill computation time, preloading the optimal number of layers minimizes wait times by eliminating layer execution gaps. If prefill computation time is equal to or exceeds key-value loading time, preloading just one layer is sufficient due to the longer prefill time. As shown in FIG. 9, experimenters demonstrate the cache management system 102 processing a query where L=5 layers with a T_{prefill}:T_{load} ratio of 1:2, and where preloading k=3 layers eliminates execution gaps.

In some cases, cache management system 102 performs prefill only for new text chunks in C-miss (text chunks that do not have an associated chunk cache) and recomputes the top-N contextualized tokens within each chunk-cache in C-hit. For each layer, during attention computation, new chunk caches and inter-attention/intra-attention for the new chunk caches are asynchronously saved in the background. Additionally, at every layer, attention output between the question and the retrieved text chunks is used to determine focused text chunks, as discussed previously. Once the focused chunks are determined, the cache management system 102 terminates recomputation for unfocused chunks.

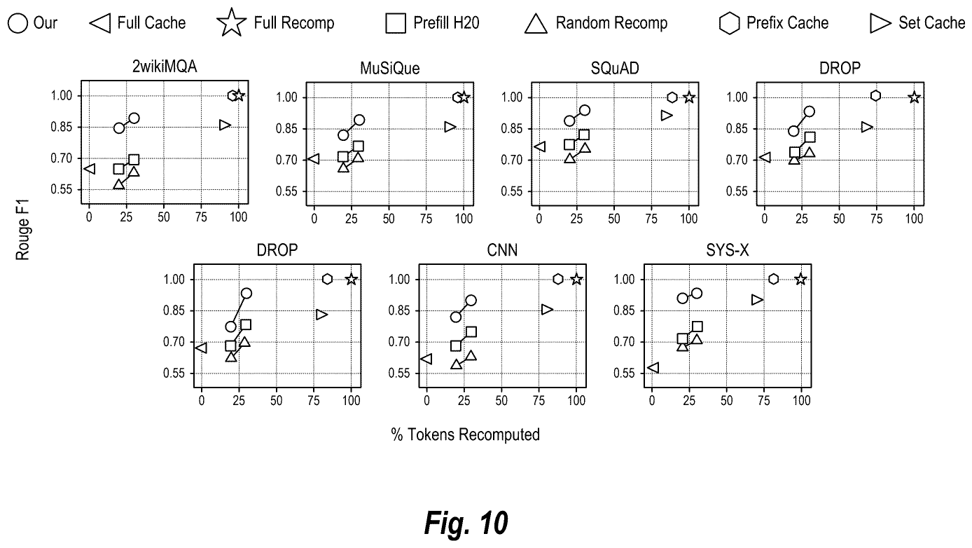

As mentioned above, in some cases, the cache management system 102 recomputes a number of tokens to achieve a desired output accuracy. Specifically, the cache management system 102 assesses the ROUGE-F1 scores for various scaling factor values and chooses the scaling factor that meets the desired output quality level. FIG. 10 illustrates a diagram of the ROUGE-1 of an answer generated utilizing the cache management system compared to other systems in accordance with one or more embodiments.

As illustrated in FIG. 10, experimenters have demonstrated improvements in comparing the performance of baseline KV-cache reuse techniques and the original LLaMA generation (i.e., full recomputation with ROUGE-F1 score=1). In these experiments, researchers have demonstrated that the cache management system 102 consistently outperforms its competitors in utilizing system LLaMA-3-8B. For example, using full cache computation incurs no recomputation of tokens, but yields low quality, with ROUGE-F1 scores dropping to 0.65 for multi-hop QA datasets (such as 2wikiMQA and MuSiQue). In contrast, by recomputing 20% of tokens with LLaMA-3-8B improves the ROUGE-F1 score by 30% and further by 42% with 30% recomputation of tokens.

As further illustrated in FIG. 10, experimenters have demonstrated that the cache management system 102 (as a contextualization-based recomputation method) also outperforms Random-Recomp (random token selection) and Prefill-H2O (high-attention token selection). Notably, random selection sometimes lowers performance even below full-cache (full recomputation; 100% tokens recomputed) as it neglects the key contextual tokens and overpowers incorrect tokens, which sometimes even shadows/underpowers crucial ones. Prefill-H2O shows only a modest 2-10% improvement over Full-Cache but struggles with multi-hop tasks. As mentioned previously, cache management system 102 identifies and recomputes critical tokens distorted by prior contexts, which enhances performance and minimizes missing or incorrect facts.

As shown in FIG. 10, experimenters have further demonstrated that the cache management system 102 achieves a ROUGE-F1 score of 0.87 with only 20% token recomputation, outperforming Full-Cache reuse (0.59) and other recomputation strategies by about 20-30%. Additionally, Prefix-Cache also saves just 18% prefill tokens, proving ineffective as compared to the cache management system 102.

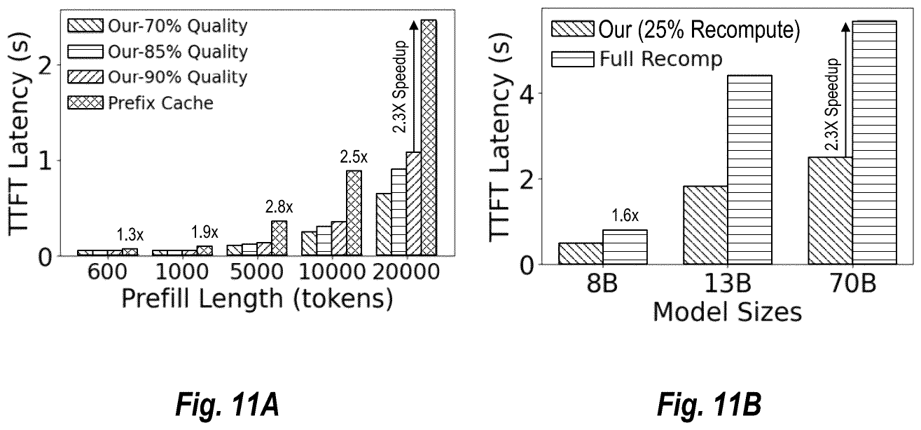

As mentioned above, the cache management system 102, reduces time-to-first-token (“TTFT”) latency. Specifically, as compared to some prefix caching systems, cache management system 102 reduces TTFT latency. FIGS. 11A-11B illustrate diagrams of time-to-first-token latency of the cache management system in accordance with one or more embodiments.

As illustrated in FIG. 11A, experimenters demonstrate the cache management system 102 compared against the Prefix Cache for requests from Sys-X across sequence lengths. For instance, Sys-X represents a real-production RAG system that helps users in setting up complex workflows for an enterprise SaaS product by answering queries and providing steps from user manuals. In these or other experiments, the cache management system 102 receives a range of sequences in a range from 600 to 20,000 tokens with an average of about 5000 tokens. When compared to Prefix Cache, cache management system 102 achieves a 2.5× speedup for LLaMA-3-8B in TTFT latency over Prefix Cache by recomputing 39% of tokens while maintaining 90% of the original quality. In some cases, cache management system 102 achieves these results because, on average, only 18% exact prefix match occurs for the requests received. Such results render Prefix Cache ineffective as compared to cache management system 102.

As illustrated in FIG. 11B, experimenters demonstrate that the cache management system 102 measures the prefill latency reduction compared to full recomputation across different model sizes. The experimenters conduct the evaluation using a batch size of 4 and a sequence length of 8192 tokens. As shown in FIG. 11B, the prefill latency reduction scales with model size, ranging from 1.62× for some systems (e.g., LLaMA-3-8B) to 2.27× for other systems (e.g., LLaMA-3-70B. Researchers demonstrate that this improvement is derived from the cache management system 102 reducing the number of tokens computed in attention across all layers of the large language model, with the gains increasing as the number of layers grows.

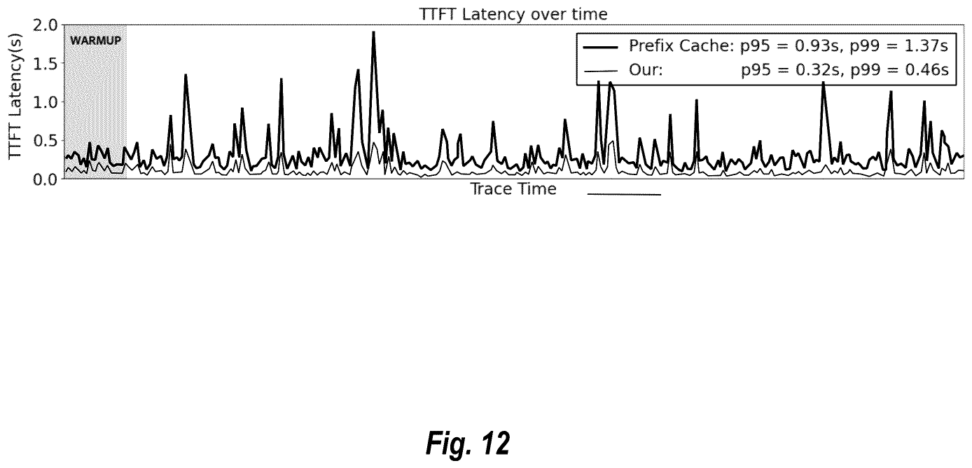

As discussed previously, the cache management system 102, reduces TTFT latency. Specifically, the cache management system 102 reduces spikes in TTFT latency. FIG. 12 illustrates a diagram of time-to-first token latency over time of the cache management system in accordance with one or more embodiments.

As shown in FIG. 12, experimenters demonstrate TTFT latencies of each request from a trace of the requests received over time by Sys-X, with a warm up period designated on the left. Researchers observe that as cache management system 102 keeps TTFT spikes significantly lower than Prefix-Cache, cache management system 102 provides a 3× reduction in the 99^{th} percentile TTFT latency. The spikes in TTFT are due to the fact that text chunks in Sys-X are subsections of user-manuals and are unequal in size. However, researchers note that when prefill lengths are high (leading to spikes) cache management system 102 reduces TTFT significantly by reusing chunk caches and avoiding quadratic computational complexity.

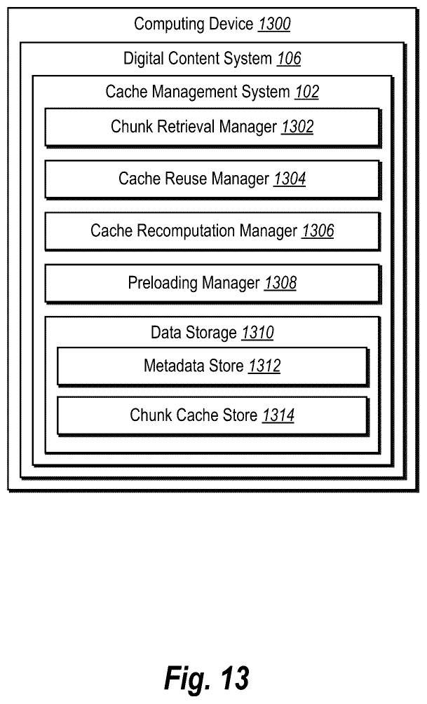

Looking now to FIG. 13, additional detail will be provided regarding components and capabilities of the cache management system 102. Specifically, FIG. 13 illustrates an example schematic diagram of the cache management system 102 on an example computing device 1300 (e.g., one or more of the client device 110 and/or the server device(s) 104). In some embodiments, the computing device 1300 refers to a distributed computing system where different managers are located on different devices, as described above. As shown in FIG. 13, the cache management system 102 includes a chunk retrieval manager 1302, a cache reuse manager 1304, a cache recomputation manager 1306, a preloading manager 1308, and a data storage 1310 including metadata store 1312 and chunk cache store 1314.

As just mentioned, the cache management system 102 includes a chunk retrieval manager 1302. In particular, the chunk retrieval manager 1302 manages, maintains, detects, determines, or identifies one or more text chunks relevant to a query. For example, the chunk retrieval manager 1302 determines a sequence of text chunks relevant to a query provided to a large language model.

As shown, the cache management system 102 also includes a cache reuse manager 1304. In particular, the cache reuse manager 1304 manages, maintains, determines or identifies chunk caches (e.g., key value caches) eligible for reuse in processing a current query. For example, the cache reuse manager determines whether a chunk cache associated with a retrieved text chunk is reusable in generating a response to a current query. Furthermore, the cache reuse manager 1304 evaluates a chunk cache for reuse relative to the attention metrics (inter-attention, intra-attention) of the chunk cache. Additionally, in some cases, the cache reuse manager 1304 determines chunk cache reusability based on the prefix arrangement of the chunk cache by comparing a first sequence of text chunks retrieved in responding to the current query to a second sequence of text chunks retrieved in responding to a prior query.

As further illustrated in FIG. 13, the cache management system 102 includes a cache recomputation manager 1306. In particular, the cache recomputation manager 1306 manages, maintains, determines, identifies, or generates recomputed caches for use in processing an input query provided to a large language model. For example, the cache recomputation manager 1306 determines one or more tokens within a chunk cache to recompute to mimic the output of a large language model that fully recomputes chunk caches associated with a text chunk. Additionally, in some cases, the cache recomputation manager 1306 determines which tokens to recompute within a chunk cache based on the contextual dependencies (inter-attention, intra attention) of the tokens relevant to a first sequence of text chunks that were retrieved during the processing of a prior query.

Additionally, the cache management system 102 includes preloading manager 1308. In particular, the preloading manager 1308 manages, maintains, or determines hierarchical loading of chunk caches for computation (or recomputation) within a large language model. For example, the preloading manager 1308 overlaps loading of chunk caches into a particular layer of the large language model with execution (computation) of chunk caches. In addition, the preloading manager 1308 retrieves chunk caches from various levels of storage (GPU memory, CPU memory, SSD memory) to minimize time-to-first-latency.

As illustrated in FIG. 13, the cache management system 102 includes data storage 1310. The data storage 1310 operates in conjunction with, or includes, the chunk retrieval manager 1302, the cache reuse manager 1304, the cache recomputation manager 1306, and/or the preloading manager 1308. As shown in FIG. 13, the data storage 1310 includes metadata store 1312, accessible and usable by other components of the cache management system 102. In some cases, the data storage 1310 also stores chunk cache store 1314, accessible and usable by other components of the cache management system 102. In some cases, the data storage 1310 communicates with the other components of the cache management system 102 to facilitate the operations and functions described herein.

In one or more embodiments, each of the components of the cache management system 102 are in communication with one another using any suitable communication technologies. Additionally, the components of the cache management system 102 is in communication with one or more other devices including one or more client devices described above. It will be recognized that although the components of the cache management system 102 are shown to be separate in FIG. 13, any of the subcomponents may be combined into fewer components, such as into a single component, or divided into more components as may serve a particular implementation. Furthermore, although the components of FIG. 13 are described in connection with the cache management system 102, at least some of the components for performing operations in conjunction with the cache management system 102 described herein may be implemented on other devices within the environment.

The components of the cache management system 102, in one or more implementations, includes software, hardware, or both. For example, the components of the cache management system 102 include one or more instructions stored on a computer-readable storage medium and executable by processors of one or more computing devices (e.g., the computing device 1300). When executed by the one or more processors, the computer-executable instructions of the cache management system 102 cause the computing device 1300 to perform the methods described herein. Alternatively, the components of the cache management system 102 comprises hardware, such as a special purpose processing device to perform a certain function or group of functions. Additionally, or alternatively, the components of the cache management system 102 includes a combination of computer-executable instructions and hardware.

Furthermore, the components of the cache management system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the cache management system 102 may be implemented as part of a stand-alone application on a personal computing device or a mobile device. Alternatively, or additionally, the components of the cache management system 102 may be implemented in any application that allows creation and delivery of marketing content to users, including, but not limited to, applications in ADOBE® CREATIVE CLOUD®, such as ADOBE® ACROBAT®, DOCUMENT CLOUD®, and EXPRESS®. “ADOBE,” “CREATIVE CLOUD,” “ACROBAT,” “DOCUMENT CLOUD,” and “EXPRESS” are either registered trademarks or trademarks of Adobe Inc. in the United States and/or other countries.

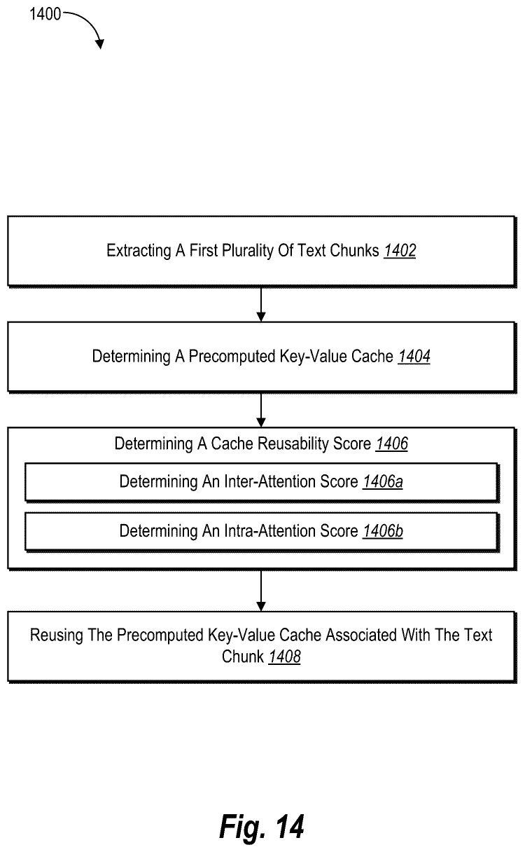

FIGS. 1-13, the corresponding text, and the examples provide a number of different systems, methods, and non-transitory computer readable media for managing and reusing chunk caches in processing a query via a large language model. In addition to the foregoing, embodiments are describable in terms of flowcharts comprising acts for accomplishing a particular result. For example, FIGS. 14-16 illustrate flowcharts of example sequences or series of acts in accordance with one or more embodiments.

While FIGS. 14-16 illustrate acts according to particular embodiments, alternative embodiments may omit, add to, reorder, and/or modify any of the acts shown in FIGS. 14-16. The acts of FIGS. 14-16 are sometimes performed as part of a method. Alternatively, a non-transitory computer readable medium comprises instructions, that when executed by one or more processors, cause a computing device to perform the acts of FIGS. 14-16. In still further embodiments, a system performs the acts of FIGS. 14-16. Additionally, the acts described herein may be repeated or performed in parallel with one another or in parallel with different instances of the same or other similar acts.

FIG. 14 illustrates a flowchart of a series of acts 1400 for reusing a precomputed key-value cache associated with a text chunk in accordance with one or more embodiments. In particular, the series of acts 1400 includes an act 1402 of extracting a first plurality of text chunks. For example, the act 1402 includes extracting a first plurality of text chunks relevant to an input query, the first plurality of text chunks arranged in a first sequence. In addition, the series of acts 1400 includes an act 1404 of determining a precomputed key-value cache. In particular, the acts 1404 involves determining, within a large language model and according to a second plurality of text chunks arranged in a second sequence, a precomputed key-value cache for a text chunk of the first plurality of text chunks.

As further illustrated in FIG. 14, the series of acts 1400 includes an act 1406 of determining a cache reusability score. In particular, the act 1406 involves determining a cache reusability score for the text chunk according to dependency metrics of tokens within the text chunk and tokens within the second plurality of text chunks. In some cases, the act 1406 includes an act 1406a of determining an inter-attention score. In various embodiments, the act 1406 also includes an act 1406b of determining an intra-attention score. In addition, the series of acts 1400 includes an act 1408 of reusing the precomputed key-value cache associated with the text chunk. Indeed, the act 1408 involves reusing, within the large language model generating a response to the input query, the precomputed key-value cache associated with the text chunk based on the cache reusability score.

In one or more embodiments, the series of acts 1400 includes an act of determining the cache reusability score for the text chunk by determining an inter-attention score indicating dependencies between the tokens within the text chunk and the tokens within the second plurality of text chunk. In addition, the series of acts 1400 includes an act of determining an intra-attention score indicating cumulative dependencies of the tokens within the text chunk.

In certain embodiments, the series of acts 1400 includes an act of determining the cache reusability score for the text chunk further by normalizing the inter-attention score between the tokens within the text chunk and the tokens within the second plurality of text chunks according to a length of the text chunk. Further, the series of acts 1400 includes an act of normalizing the intra-attention score of the text chunk according to the length of the text chunk.

In some cases, the series of acts 1400 includes an act of determining the cache reusability score by generating a prefix overlap score by comparing the first plurality of text chunks arranged in the first sequence and the second plurality of text chunks arranged in the second sequence. In certain embodiments, the series of acts 1400 includes an act of generating, from the prefix overlap score, a modified prefix overlap score by generating an order penalty score that penalizes the text chunk for discrepancies in ordering between the first sequence and the second sequence.

In one or more embodiments, the series of acts 1400 includes an act of reusing the precomputed key-value cache associated with the text chunk by determining a first cache reusability score for a first precomputed key-value cache variant of the text chunk. In addition, the series of acts 1400 includes an act of determining a second cache reusability score for a second precomputed key-value cache variant of the text chunk, the first cache reusability score being higher than the second cache reusability score. Further, the series of acts 1400 includes reusing the precomputed key-value cache associated with the first precomputed key-value cache variant of the text chunk based on the first cache reusability score and the second cache reusability score.

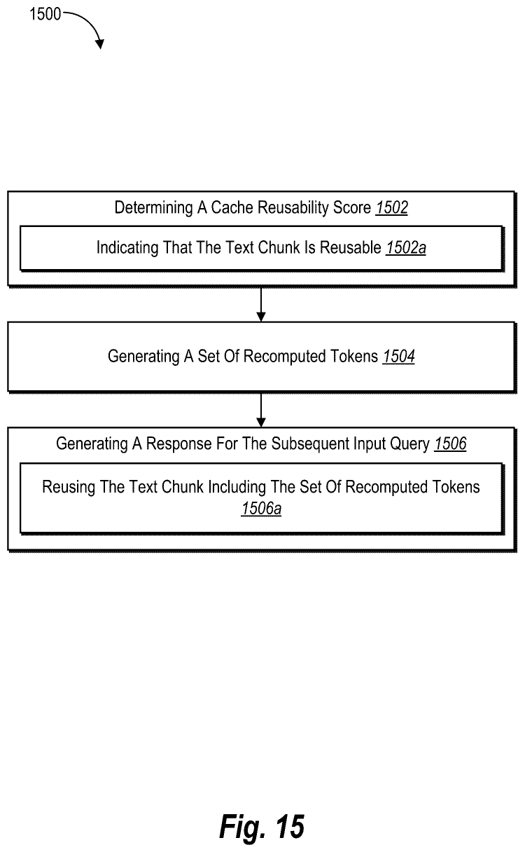

FIG. 15 illustrates a flowchart of a series of acts for recomputing a set of tokens within a text chunk in accordance with one or more embodiments. In particular, the series of acts 1500 includes an act 1502 of determining a cache reusability score. For example, act 1502 involves determining, for a text chunk within a sequence of text chunks corresponding to an input query, a cache reusability score indicating that the text chunk is reusable by a large language model to generate a response to a subsequent input query. In some cases, the act 1502 includes an act 1502a of indicating that the text chunk is reusable.

As shown, the series of acts 1500 includes an act 1504 of generating a set of recomputed tokens. For example, the act 1504 involves generating, according to the cache reusability score, a set of recomputed tokens within the text chunk.

As also shown in FIG. 15, the series of acts 1500 includes an act 1506 of generating a response for the subsequent input query. For example, the act 1506 involves generating, utilizing the large language model, a response for the subsequent input query by reusing, within the large language model, the text chunk including the set of recomputed tokens. In some cases, the act 1506 includes an act 1506a of reusing the text chunk including the set of recomputed tokens.

In addition, the series of acts 1500 includes an act of generating the set of recomputed tokens within the text chunk comprise by determining an inter-attention score for a token within the text chunk relative to a second plurality of text chunks arranged in a second sequence, the inter-attention score indicating dependencies between the token and the second plurality of text chunks. In these or other embodiments, the series of acts 1500 includes an act of generating a recomputed token according to the inter-attention score for the token of the text chunk. Additionally, the series of acts 1500 includes an act of generating the set of recomputed tokens within the text chunk including the recomputed token.

In one or more embodiments, the series of acts 1500 includes an act of generating the set of recomputed tokens within the text chunk by determining a number of tokens within the text chunk to recompute based on the cache reusability score and a length of the text chunk. Additionally, the series of acts includes an act of generating the set of recomputed tokens within the text chunk based on the number of tokens to recompute.

In some embodiments, the series of acts 1500 includes an act of generating the set of recomputed tokens within the text chunk by determining an inter-attention score for the text chunk indicating attention of the text chunk relative to the subsequent input query. In some cases, the series of acts 1500 includes an act of determining the text chunk is a focused chunk based on the inter-attention score of the text chunk. Additionally, the series of acts 1500 includes an act of generating a set of recomputed tokens within the text chunk based on determining that the text chunk is a focused chunk. In various embodiments, the series of acts 1500 includes an act of determining a second inter-attention score for a second text chunk indicating attention of the second text chunk relative to the subsequent input query. Further, the series of acts 1500 includes an act of determining the second text chunk is an unfocused chunk based on comparing the second inter-attention score and the inter-attention score of the text chunk. Moreover, the series of acts 1500 includes an act of terminating recomputation of the second text chunk based on determining the second text chunk is an unfocused chunk.

In some embodiments, the series of acts 1500 includes an act of generating the set of recomputed tokens within the text chunk by determining, in a first layer of a large language model, a first inter-attention score for the text chunk indicating attention of the text chunk relative to the subsequent input query. In addition, the series of acts 1500 includes an act of determining, in a second layer of a large language model, a second inter-attention score for the text chunk. Further, the series of acts 1500 includes an act of determining that the text chunk is a focused chunk based on a difference between the first inter-attention score and the second inter-attention score. Moreover, the series of acts 1500 includes an act of generating a set of recomputed tokens within the text chunk based on determining that the text chunk is a focused chunk.

In one or more embodiments, the series of acts 1500 includes an act of generating a response to the subsequent input query by reusing the text chunk including the set of recomputed tokens. In addition, the series of acts 1500 includes an act of updating metadata associated with the text chunk indicating reuse frequency based on reusing the text chunk including the set of recomputed tokens. In various cases, the series of acts 1500 includes an act of generating a key-value cache associated with the text chunk including the set of recomputed tokens. In addition, the series of acts 1500 includes an act of storing the key-value cache in a key-value map.

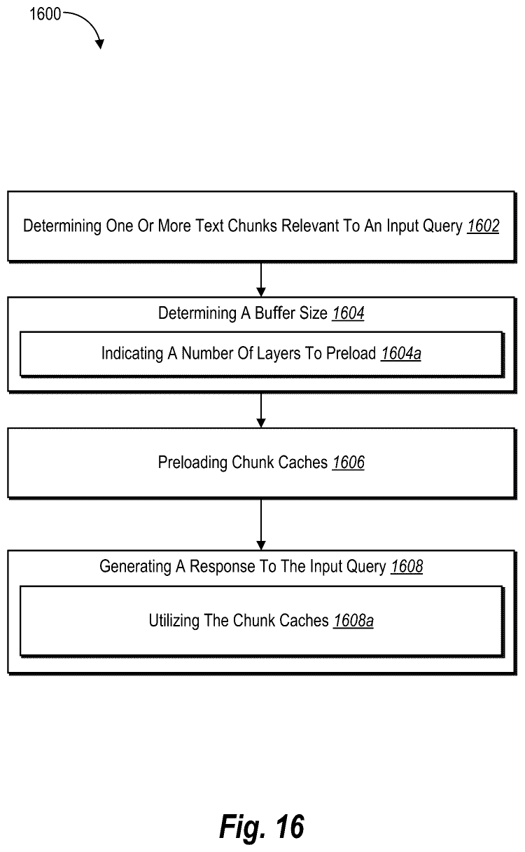

FIG. 16 illustrates a flowchart of a series of acts for layer-wise preloading of chunk caches in accordance with one or more embodiments. In particular, the series of acts 1600 includes an act 1602 of determining one or more text chunks relevant to an input query. For example, the act 1602 involves determining, for a large language model, one or more text chunks relevant to an input query to recompute according to a cache reusability score.

As shown, the series of acts 1600 includes an act 1604 of determining a buffer size. In particular, the act 1604 involves determining a buffer size indicating a number of layers to preload with chunk caches corresponding to the one or more text chunks based on one or more of a number of layers of the large language model, a prefill computation time for the large language model, or a key-value loading time for the chunk caches. In some cases, the act 1604 includes an act 1604a of indicating a number of layers to preload.

As further shown in FIG. 16, the series of acts 1600 includes an act 1606 of preloading chunk caches. In particular, the act 1606 involves preloading, during processing of a first layer of the large language model, chunk caches into one or more additional layers corresponding to the buffer size.

As illustrated, the series of acts 1600 includes an act 1608 of generating a response to the input query. Specifically, the act 1608 involves generating a response to the input query utilizing the chunk caches preloaded within the large language model. In some cases, the act 1608 includes act 1608a of utilizing the chunk caches.

In some embodiments, the series of acts 1600 includes an act of preloading the chunk caches by preloading the chunk caches into a graphics processing unit memory for a graphics processing unit implementing the large language model.

In some cases, the series of acts 1600 includes an act of preloading the chunk caches by determining that the chunk caches are not in graphics processing unit memory. Additionally, the series of acts 1600 includes an act of preloading the chunk caches into the graphics processing unit memory by retrieving the chunk caches from device storage.

In one or more embodiments, the series of acts 1600 includes an act of preloading the chunk caches by overlapping loading of the chunk caches and execution of the large language model, wherein execution of the large language model comprises a prefill computation of one or more new text chunks and a recomputation of tokens of one or more text chunks according to the cache reusability score.

In these or other embodiments, the series of acts 1600 includes an act of determining the buffer size comprises by determining a prefill computation time for the large language model. Additionally, the series of acts 1600 includes an act of determining a key-value loading time for the chunk caches. Further, the series of acts 1600 includes an act of determining a loading ratio based on the prefill computation time and the key-value loading time.

In various cases, the series of acts 1600 includes an act of determining one or more text chunks relevant to an input query by determining one or more variants of a text chunk of the one or more text chunks. Additionally, the series of acts 1600 includes an act of generating a reusability score for the one or more variants of the text chunk. Further, the series of acts 1600 includes an act of selecting a variant of the one or more variants based on the reusability score.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 17 illustrates, in block diagram form, an example computing device 1700 (e.g., the computing device 1300, the client device 110, and/or the server device(s) 104) that may be configured to perform one or more of the processes described above. As shown by FIG. 17, the computing device can comprise a processor(s) 1702, memory 1704, a storage device 1706, an I/O interface 1708, and a communication interface 1710.

In particular embodiments, processor(s) 1702 includes hardware for executing instructions, such as those making up a computer program. As an example, and not by way of limitation, to execute instructions, processor(s) 1702 may retrieve (or fetch) the instructions from an internal register, an internal cache, memory 1704, or a storage device 1706 and decode and execute them. The computing device 1700 includes memory 1704, which is coupled to the processor(s) 1702. The memory 1704 may be used for storing data, metadata, and programs for execution by the processor(s). The memory 1704 may include one or more of volatile and non-volatile memories. The memory 1704 may be internal or distributed memory. The computing device 1700 includes a storage device 1706 includes storage for storing data or instructions. As an example, and not by way of limitation, storage device 1706 can comprise a non-transitory storage medium described above. The computing device 1700 also includes one or more input or output (“I/O”) devices/interfaces 1708, which are provided to allow a user to provide input to (such as user strokes), receive output from, and otherwise transfer data to and from the computing device 1700. These I/O devices/interfaces 1708 may include a mouse, keypad or a keyboard, a touch screen, camera, optical scanner, network interface, modem, other known I/O devices or a combination of such I/O devices/interfaces 1708.

The computing device 1700 can further include a communication interface 1710. The communication interface 1710 can include hardware, software, or both. The communication interface 1710 can provide one or more interfaces for communication (such as, for example, packet-based communication) between the computing device and one or more other computing devices (e.g., computing device 1300) or one or more networks. The computing device 1700 can further include a bus 1712. The bus 1712 can comprise hardware, software, or both that couples components of computing device 1700 to each other.

What is claimed is:

1. A computer-implemented method comprising:
extracting a first plurality of text chunks relevant to an input query, the first plurality of text chunks arranged in a first sequence;
determining, within a large language model and according to a second plurality of text chunks arranged in a second sequence, a precomputed key-value cache for a text chunk of the first plurality of text chunks;
determining a cache reusability score for the text chunk according to dependency metrics of tokens within the text chunk and tokens within the second plurality of text chunks; and
reusing, within the large language model generating a response to the input query, the precomputed key-value cache associated with the text chunk based on the cache reusability score.

2. The computer-implemented method of claim 1, wherein determining the cache reusability score for the text chunk comprises:
determining an inter-attention score indicating dependencies between the tokens within the text chunk and the tokens within the second plurality of text chunks; and
determining an intra-attention score indicating cumulative dependencies of the tokens within the text chunk.

3. The computer-implemented method of claim 2, wherein determining the cache reusability score for the text chunk further comprises:
normalizing the inter-attention score between the tokens within the text chunk and the tokens within the second plurality of text chunks according to a length of the text chunk; and
normalizing the intra-attention score of the text chunk according to the length of the text chunk.

4. The computer-implemented method of claim 1, wherein determining the cache reusability score comprises generating a prefix overlap score by comparing the first plurality of text chunks arranged in the first sequence and the second plurality of text chunks arranged in the second sequence.

5. The computer-implemented method of claim 4, further comprising generating, from the prefix overlap score, a modified prefix overlap score by generating an order penalty score that penalizes the text chunk for discrepancies in ordering between the first sequence and the second sequence.

6. The computer-implemented method of claim 1, wherein reusing the precomputed key-value cache associated with the text chunk comprises:
determining a first cache reusability score for a first precomputed key-value cache variant of the text chunk;
determining a second cache reusability score for a second precomputed key-value cache variant of the text chunk, the first cache reusability score being higher than the second cache reusability score; and
reusing the precomputed key-value cache associated with the first precomputed key-value cache variant of the text chunk based on the first cache reusability score and the second cache reusability score.

7. A system comprising:
a memory component; and
one or more processing devices coupled to the memory component, the one or more processing devices to perform operations comprising:
determining, for a text chunk within a sequence of text chunks corresponding to an input query, a cache reusability score indicating that the text chunk is reusable by a large language model to generate a response to a subsequent input query;
generating, according to the cache reusability score, a set of recomputed tokens within the text chunk; and
generating, utilizing the large language model, a response for the subsequent input query by reusing, within the large language model, the text chunk including the set of recomputed tokens.

8. The system of claim 7, wherein generating the set of recomputed tokens within the text chunk comprises:
determining an inter-attention score for a token within the text chunk relative to a second plurality of text chunks arranged in a second sequence, the inter-attention score indicating dependencies between the token and the second plurality of text chunks;
generating a recomputed token according to the inter-attention score for the token of the text chunk; and
generating the set of recomputed tokens within the text chunk including the recomputed token.

9. The system of claim 7, wherein generating the set of recomputed tokens within the text chunk comprises:
determining a number of tokens within the text chunk to recompute based on the cache reusability score and a length of the text chunk; and
generating the set of recomputed tokens within the text chunk based on the number of tokens to recompute.

10. The system of claim 7, wherein generating the set of recomputed tokens within the text chunk comprises:
determining an inter-attention score for the text chunk indicating attention of the text chunk relative to the subsequent input query;
determining the text chunk is a focused chunk based on the inter-attention score of the text chunk; and
generating a set of recomputed tokens within the text chunk based on determining that the text chunk is a focused chunk.

11. The system of claim 10, further comprising:
determining a second inter-attention score for a second text chunk indicating attention of the second text chunk relative to the subsequent input query,
determining the second text chunk is an unfocused chunk based on comparing the second inter-attention score and the inter-attention score of the text chunk; and
terminating recomputation of the second text chunk based on determining the second text chunk is an unfocused chunk.

12. The system of claim 7, wherein generating the set of recomputed tokens within the text chunk comprises:
determining, in a first layer of a large language model, a first inter-attention score for the text chunk indicating attention of the text chunk relative to the subsequent input query;
determining, in a second layer of a large language model, a second inter-attention score for the text chunk;
determining that the text chunk is a focused chunk based on a difference between the first inter-attention score and the second inter-attention score; and
generating a set of recomputed tokens within the text chunk based on determining that the text chunk is a focused chunk.

13. The system of claim 7, further comprising:
generating a response to the subsequent input query by reusing the text chunk including the set of recomputed tokens; and
updating metadata associated with the text chunk indicating reuse frequency based on reusing the text chunk including the set of recomputed tokens.

14. The system of claim 7, further comprising:
generating a key-value cache associated with the text chunk including the set of recomputed tokens; and
storing the key-value cache in a key-value map.

15. A non-transitory computer-readable medium storing instructions which, when executed by a processing device, cause the processing device to perform operations comprising:
determining, for a large language model, one or more text chunks relevant to an input query to recompute according to a cache reusability score;
determining a buffer size indicating a number of layers to preload with chunk caches corresponding to the one or more text chunks based on one or more of a number of layers of the large language model, a prefill computation time for the large language model, or a key-value loading time for the chunk caches;
preloading, during processing of a first layer of the large language model, chunk caches into one or more additional layers corresponding to the buffer size; and
generating a response to the input query utilizing the chunk caches preloaded within the large language model.

16. The non-transitory computer-readable medium of claim 15, wherein preloading the chunk caches comprises preloading the chunk caches into a graphics processing unit memory for a graphics processing unit implementing the large language model.

17. The non-transitory computer-readable medium of claim 15, wherein preloading the chunk caches comprises:
determining that the chunk caches are not in graphics processing unit memory; and
preloading the chunk caches into the graphics processing unit memory by retrieving the chunk caches from device storage.

18. The non-transitory computer-readable medium of claim 15, wherein preloading the chunk caches comprises overlapping loading of the chunk caches and execution of the large language model, wherein execution of the large language model comprises a prefill computation of one or more new text chunks and a recomputation of tokens of one or more text chunks according to the cache reusability score.

19. The non-transitory computer-readable medium storing instructions of claim 15, wherein determining the buffer size comprises:
determining a prefill computation time for the large language model;
determining a key-value loading time for the chunk caches; and
determining a loading ratio based on the prefill computation time and the key-value loading time.

20. The non-transitory computer-readable medium storing instructions of claim 15, wherein determining one or more text chunks relevant to an input query comprises:
determining one or more variants of a text chunk of the one or more text chunks;
generating a reusability score for the one or more variants of the text chunk; and
selecting a variant of the one or more variants based on the reusability score.
